(19) United States
(12) Patent Application Publication
(10) Pub. No.: US 2006/0232544 A1
(43) Pub. Date: Oct. 19, 2006

(54) Liquid crystal display device

(75) Inventor: Kazuhiro Sakashita, Tokyo (JP)

Correspondence Address: BUCHANAN, INGERSOLL & ROONEY PC, POST OFFICE BOX 1404, ALEXANDRIA, VA, 22313-1404, US

(73) Assignee: Renesas Technology Corporation, Tokyo (JP)

(21) Appl. No.: 11/403,915

(22) Filed: Apr. 14, 2006

(30) Foreign Application Priority Data
Apr. 18, 2005 (JP) 2005-119359

(51) Int. Cl. G09G 3/36

(52) U.S. Cl. 345/102

(57) ABSTRACT

An object of the present invention is to present a transmission type liquid crystal display device capable of achieving at least one of reduction of size of device and enhancement of performance of operation and display. A liquid crystal panel is divided into four divided regions in vertical direction in plan view, and corresponding to these divided regions, four ray emission light sources composed of fluorescent lamps are disposed vertically at the left side of a light guide plate, and the light emitted from the ray emission light sources illuminates the divided regions by way of the light guide plate. By turning on and off switches, the ray emission light sources are independently controlled to be lit up or put out, and only in a specific time including the time of all pixels of divided regions settling at target transmissivity, one ray emission light source out of ray emission light sources responsible for a corresponding divided region is lit up (illuminated, light-emitted).

### BACKGROUND OF THE INVENTION

1. Field of the Invention

The present invention relates to a transmission type liquid crystal display device, and more particularly to enhancement of moving image display performance.

2. Description of the Background Art

A transmission type liquid crystal display device using a liquid crystal panel has many advantages including small size (thin design), light weight, and saving of energy. In combination with recently spreading digital broadcast, it is rapidly increasing in use in recent years. Operating principle of liquid crystal is described, for example, in “Principle and technology of liquid crystal display,” Sharp Corporation website, URL: http://www.sharp.co.jp/products/lcd/tech/index2.html, searched on Mar. 16, 2005 (Document 1).

On the other hand, in the present liquid crystal technology, as compared with the cathode-ray tube technology, the response speed is low, and the moving image is not sharp, which are the important problems to be solved.

(Explanation and Analysis of Cause and Factor of Poor Moving Image Performance)

Two factors may be considered as cause of poor moving image performance of liquid crystal. One is low operation (long write response time) until actually changed to desired transmissivity after writing of data when writing into liquid crystal cells (color pixels of R, G, B). The other is hold type display system for holding the emission to next data because data is held until new data is written next, after once executing writing in a pixel in the liquid crystal display system, as compared with the cathode-ray tube display system which actually impulse display shortly decreases in emission of light after emitting once. These problems are discussed, for example, in “Third-Generation Feedforward Driving,” Jun Someya, Information Display, February 2004, Vol. 20, No. 2, pp. 16-20 (Document 2), and “Improving The Moving-Image Quality of LCDs Using Impulse Driving,” Jun-ichi Ohwada, Information Display, June 2004, Vol. 20, No. 6, pp. 24-27 (Document 3).

(Problem in Improvement Measure of Response Speed)

An ordinary television broadcast displays 60 fields per second, and hence one field is displayed in about 16.7 ms. Response speed of existing liquid crystal panel is generally about 20 to 40 ms at most, and at the present the development is promoted for the purpose of achieving the response speed within a maximum of 16.7 ms, and it is proposed, for example, in Document 1, to accelerate the response speed of liquid crystal by applying a slightly excessive voltage temporarily.

As a result, the target of 16.7 ms is cleared at the present, and response speed of about 8 ms is achieved depending on the case. As described in non-patent document 2, there is reported a disadvantage that as for enhancement of response speed, however, even if a response speed shorter than 5 ms is realized, as discussed in Document 2, as far as the emission is of hold type, edges are not sharp enough in the case of a moving image, and the quality is inferior compared with the moving image display of impulse emission type cathode-ray tube display.

(Problems of Conventional Impulse Drive)

Accordingly, if desired to have favorable moving image display performance equivalent to cathode-ray tube, not only enhancement of response speed, but also display system of impulse drive system should be required.

In Document 2, to realize the impulse type display system, a method of flickering the backlight is proposed together with a method of displaying by inserting an image of total black screen between fields of ordinary moving image. Further, Document 2 proposes to set the rate of black image and rate of display of ordinary image at about 1:1, but other researchers are reporting impulse emission of waveform width of about 4 ms should be required.

However, if attempted to flicker the backlight in the conventional liquid crystal panel, it is known that the following problems are caused. In the liquid crystal panel of the present level, since response speed (of writing) is slow, there is no time zone of convergence of all pixels within target transmissivity.

Next, to produce a time zone of convergence of all pixels within target transmissivity, it is conceived to shorten the writing time of all panels from start of writing of first line (row) to end of writing of final line (row).

It is first attempted to double the writing speed of image data, and, for example, put out the backlight, write data in entire area in half field time (about 8.4 ms), and light up the backlight in remaining half field time to display the data.

In this method, however, between the first line of writing the data and the last line of writing the data, there is a difference of about half frame period (16.7/2 ms), and even in the high speed type of response speed of 8 ms, enough time for illuminating the backlight cannot be obtained.

To calculate reversely the time required for impulse emission of 4 ms, for example, the total of data writing into entire screen and response speed is (16.7-4) ms or less. Suppose the response speed to be 8 ms, writing in all rows must be finished in about 4.7 ms.

Therefore, to realize impulse emission system by conventional panel, not only high response speed (about 8 ms) is needed, but also very fast speed is demanded in total writing time in pixels (about ¼ frame; about 4 ms).

To realize impulse emission system by conventional panel, a conventional technology and a writing system, as well as the required performance and procedure are significantly different, which requires a newly great change of control circuit and thus leads to a problem such as new LSI development.

In particular, the writing speed must be increased by about 4 times, and considering that the source driver circuit requires transfer clock of about tens to hundreds of megaHz at the present, which is one of the causes of difficulty in saving of board cost, the bus width must be increased by 4 times or other measures should be necessary, which may lead to problems such as increase of board area, increase of noise, and hence increase of manufacturing cost, and it is nearly impossible at the present technical level.

Insertion of black screen is discussed. In black screen insertion, in every period of one ordinary field, ordinary pixel and black pixel are written in one pixel, and it is equivalent to writing of fields 120 times per second. As a result, both increase of writing speed by two times and enhancement of response performance are required, and the manufacturing cost is increased, although not extremely increased as in flickering system of backlight.

Concerning variation of response speed in relation to data writing, since it depends greatly on combination of gradation of previous frame and gradation of present frame, for determining the quantity of overdrive, generally, the gradation of previous frame is stored in the frame memory, and by reference to it and the gradation of present frame, the writing acceleration is determined, as disclosed in Document 2.

Generally, the response speed from intermediate gradation to intermediate gradation tends to be slower, as disclosed in Document 2.

Considering from these two respects, by inserting a black screen, since the data of the frame before the ordinary screen frame is fixed (black screen), the memory frame for storing the previous writing data is not needed, and since this is response speed from black screen, as compared with response speed from intermediate gradation, the response speed itself is also expected to be improved.

Thus, as compared with the backlight flickering system, it is expected that the rate of increase of response speed and writing speed of one screen may be curtailed, but the problem is worsening of power consumption efficiency due to decrease in quantity of light by insertion of black screen.

The conventional backlight illuminates the entire screen, and in the black screen insertion system, the backlight must be always lit while displaying black screen. That is, half time of image display of a total of 120 fields per second is black screen, and the quantity of light actually used in image display is half quantity of ordinary display system. Therefore, supposing the brightness of the backlight to be constant, the screen brightness is half of ordinary display.

This is a problem for improvement of luminance which is one of the problems in development of liquid crystal panel, and to double the light brightness, consequently, the quantity of lights must be doubled, or the power consumption of lights must be doubled to emphasize the brightness. Anyway, as a result, to obtain the same brightness as in ordinary liquid crystal panel, the power consumption is required to be increased by about two times.

In the backlight flickering system, in order to maintain the same brightness as the ordinary liquid crystal panel, if the peak luminance of backlight is doubled and peak power consumption is required to be doubled, the lights are put out in half of the time, and the power is not consumed for the period, and hence the average power consumption is not increased, but different to this, indeed, the power consumption, heat generation and noise are increased, and countermeasure expenses are added to the manufacturing cost.

To solve these problems, Japanese Patent Application Laid-Open No. 11-202286 (1999) (Document 4) discloses a liquid crystal display device for illuminating plural luminous regions (backlight regions) by scanning sequentially in synchronism with vertical sync signals.

However, four fluorescent lamps are employed on the rear side of a liquid crystal display device disclosed in Document 4 as an illumination means of a light emission regions divided into four, which brings about obstacles to miniaturization of a transmission type liquid crystal module composed of an illumination means and a liquid crystal panel. Further, light from a lighted fluorescent lamp diffuses into the other divided regions of a liquid crystal panel than the corresponding one, resulting in a problem that performance degradation in display of a moving picture is caused.

### SUMMARY OF THE INVENTION

To present a transmission type liquid crystal display device capable of achieving at least one of reduction of size of device and enhancement of performance of operation and display.

According to a first aspect of the present invention, the liquid crystal display device comprises a liquid crystal panel, a plurality of divided backlight means, and a backlight on/off control unit.

The liquid crystal panel displays an image on a display screen composed of pixels in M columns and N rows, and the display screen includes plural divided regions divided by a specified number of rows.

The plurality of divided backlight means are disposed corresponding to the plural divided regions on the display screen, and illuminate corresponding divided regions respectively, and each includes an emission light source and a partial light guide portion. The emission light sources are disposed at the lateral side of the display screen in a plan view as seen from the display screen of the liquid crystal panel. The partial light guide portions guide the incident light from the emission light source and illuminate the corresponding divided region of the liquid crystal panel.

The backlight on/off control unit performs a backlight on/off control operation controlling lighting and extinguishing of the plurality of divided backlight means. The backlight on/off control operation includes a control operation for illuminating the corresponding divided backlight means at least in part of the period of reaching a target transmissivity defined by the image data in each one of the plural divided regions, and for lighting and extinguishing the plurality of divided backlight means in one frame period, respectively.

The liquid crystal display device illuminates the corresponding divided backlight means in the period of achieving the target transmissivity. in all pixels in each one of the plural divided regions by backlight on/off control unit, and realizes impulse type display system even in the write response time that can be realized by the prior art, so that the operation and display performance can be enhanced.

In addition, by installing the specified emission light sources at the lateral side of the display screen, increase of thickness of liquid crystal module composed of liquid crystal panel and plurality of backlight means can be avoided, and therefore the device can be easily reduced in size.

According to a second aspect of the present invention, the liquid crystal display device comprises a liquid crystal panel, a plurality of divided backlight means, and a backlight on/off control unit.

The liquid crystal panel displays an image on a display screen composed of pixels in M columns and N rows, and the display screen includes plural divided regions divided by a specified number of rows. The plurality of divided backlight means are disposed corresponding to the plural divided regions on the display screen, and illuminate corresponding divided regions respectively from spot emission light sources as light sources.

The backlight on/off control unit performs a backlight on/off control operation for controlling lighting and extinguishing of the plurality of divided backlight means. The backlight on/off control operation includes a control operation for illuminating the corresponding divided backlight means at least in part of the period of reaching the target transmissivity defined by the image data in each one of the plural divided regions, and for lighting and extinguishing the plurality of divided backlight means in one frame period, respectively.

The liquid crystal display device illuminates the corresponding divided backlight means in the period of achieving the target transmissivity in all pixels in each one of the plural divided regions by backlight on/off control unit, and realizes impulse type display system even in the write response time that can be realized by the prior art, so that the operation and display performance can be enhanced.

In addition, by using spot emission light sources as the light source, operation life of emission light source for lighting and extinguishing operation can be extended. Further, lighting and extinguishing response speed of the emission light sources can be enhanced, and it is possible to control at shorter time intervals, and as compared with ray emission light sources, the size can be reduced, so that the device can be manufactured in a thin design while maintaining a sufficient brightness.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram of transmission type liquid crystal display device in a first embodiment of the present invention;

FIG. 2 is an explanatory diagram of configuration of gate driver, liquid crystal, and source driver;

FIG. 3 is a timing chart of signal waveform during operation of source driver and gate driver;

FIG. 4 is an explanatory diagram of backlight of liquid crystal display device in the first embodiment;

FIG. 5 is an explanatory diagram of a structure (example 1) of light guide plate in the first embodiment;

FIG. 6 is an explanatory diagram of a structure (example 2) of light guide plate in the first embodiment;

FIG. 7 is an explanatory diagram of light illumination distribution divided by the divided regions;

FIG. 8 is a timing chart showing the timing relation of writing of data and backlight on/off in divided regions in the first embodiment;

FIG. 9 is a circuit diagram of backlight on/off control unit;

FIG. 10 is an explanatory diagram of backlight of liquid crystal display device in a second embodiment;

FIG. 11 is an explanatory diagram of a sectional structure of light guide plate in the second embodiment;

FIG. 12 is an explanatory diagram of backlight of liquid crystal display device in a third embodiment;

FIG. 13 is an explanatory diagram of backlight of liquid crystal display device in a fourth embodiment;

FIG. 14 is an explanatory diagram of backlight of liquid crystal display device in a fifth embodiment;

FIG. 15 is an explanatory diagram of backlight of liquid crystal display device in a sixth embodiment;

FIG. 16 is an explanatory diagram of backlight of liquid crystal display device in a seventh embodiment;

FIG. 17 is an explanatory diagram of backlight of liquid crystal display device in an eighth embodiment;

FIG. 18 is a graph showing an example of red color display in the backlight of ordinary white color light;

FIG. 19 is a graph showing an example of red color display in the backlight of RGB spot emission light source groups;

FIG. 20 is an explanatory diagram of backlight of liquid crystal display device in a ninth embodiment;

FIG. 21 is an explanatory diagram of backlight of liquid crystal display device in a tenth embodiment;

FIG. 22 is an explanatory diagram of backlight of liquid crystal display device in an eleventh embodiment;

FIG. 23 is a timing chart showing the timing relation of data writing and backlight lighting and extinguishing in divided regions in a twelfth embodiment;

FIG. 24 is a timing chart showing the timing relation of data writing and backlight lighting and extinguishing in divided regions in a thirteenth embodiment;

FIG. 25 is a timing chart showing the timing relation of data writing and backlight lighting and extinguishing in divided regions in a fourteenth embodiment;

FIG. 26 is a block diagram of transmission type liquid crystal display device in a fifteenth embodiment;

FIG. 27 is a block diagram of transmission type liquid crystal display device in a sixteenth embodiment; and

FIG. 28 is a block diagram of transmission type liquid crystal display device in a seventeenth embodiment.

### DESCRIPTION OF THE PREFERRED EMBODIMENTS

### First Embodiment

(Entire Configuration)

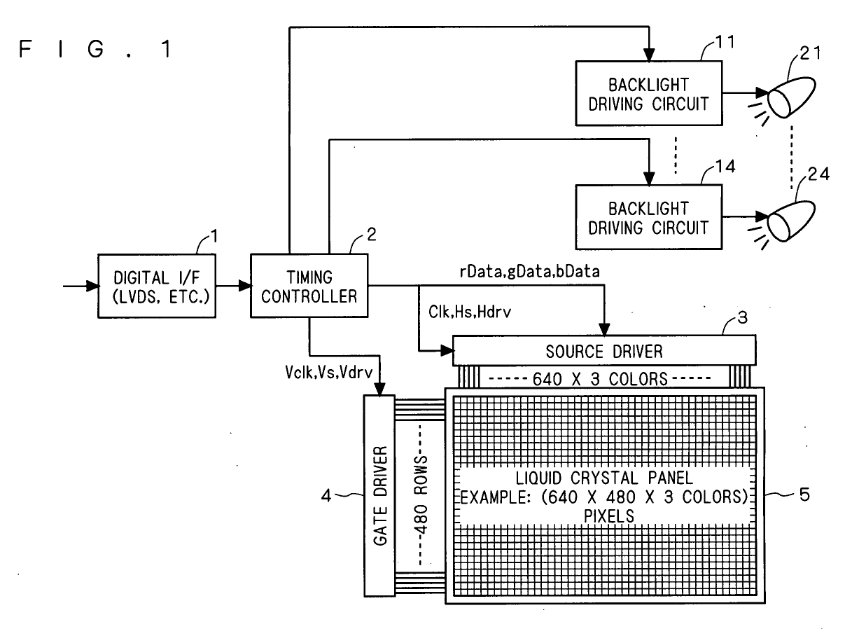

FIG. 1 is a block diagram of transmission type liquid crystal display device in a first embodiment of the present invention. This liquid crystal display device is a liquid crystal panel device having a display screen of pixel configuration of 640 columns×3 colors×480 rows.

The liquid crystal display device mainly includes a liquid crystal panel 5 having color pixels arrayed in matrix, a source driver (circuit) 3, a gate driver (circuit) 4, a timing controller (timing control unit) 2, a digital I/F (circuit) 1, backlight driving circuits 11 to 14, and divided backlights 21 to 24.

A digital signal sent from a digital IF circuit (low voltage differential signaling, LVDS, or the like) of television is received in a receiver of the digital I/F 1 (LVDS, or the like), and is put into the timing controller 2.

The timing controller 2 sends image data (analog image signal rData, analog image signal gData, analog image signal bData) to the source driver 3 at proper timing, and generates timing signals for driving control, transfer clock Clk, horizontal start signal Hs, and horizontal drive signal Hdrv, and transfers to the source driver 3.

At the same time, the timing controller 2 generates timing signals, vertical (transfer) clock Vclk, vertical start signal Vs, and vertical drive signal Vdrv, and transmits to the gate driver 4. As described below, the timing controller 2 also generates control signals for backlight driving circuits 11 to 14.

The source driver 3 takes in the portion of one row of image data of each color pixel from the transmitted signals, and sends out corresponding image signals in batch to the source wiring from the output terminal.

On the other hand, the gate driver 4 sends out an ON signal to a proper gate wiring and at proper timing, so as to turn on the MOS transistor of color pixel of corresponding row so that the image data for the portion of one row may be issued in batch from the source driver 3.

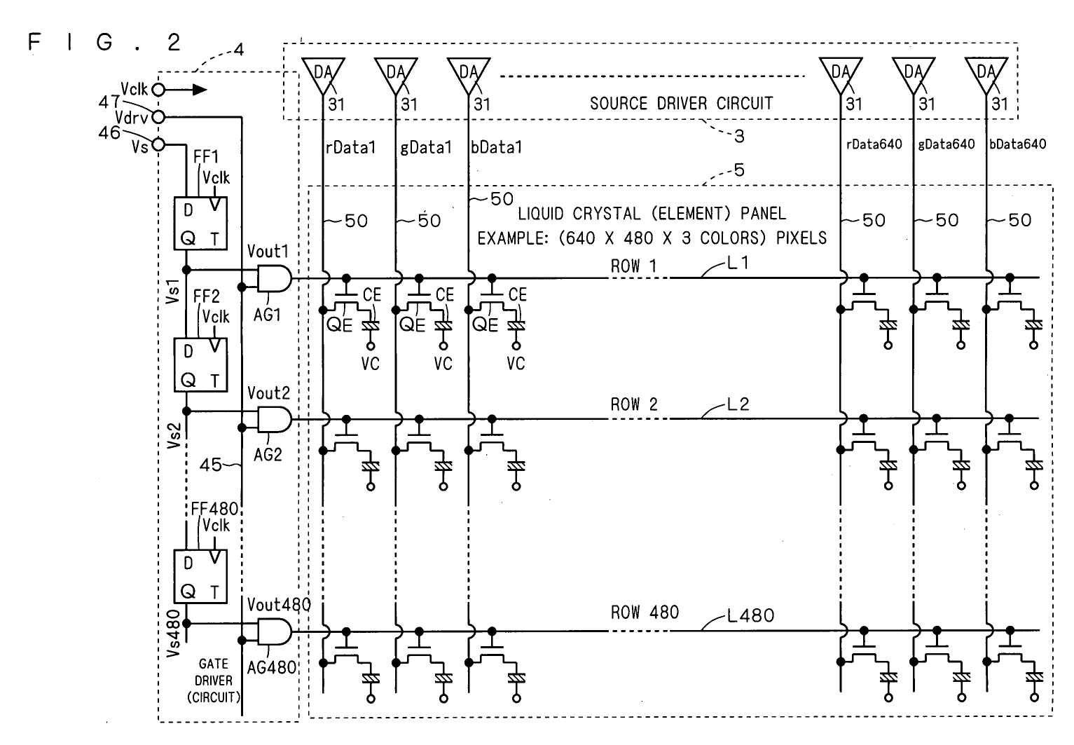

FIG. 2 is an explanatory diagram of configuration of circuit of gate driver 4 and liquid crystal (element) panel 5, and relation of their connection to the source driver 3.

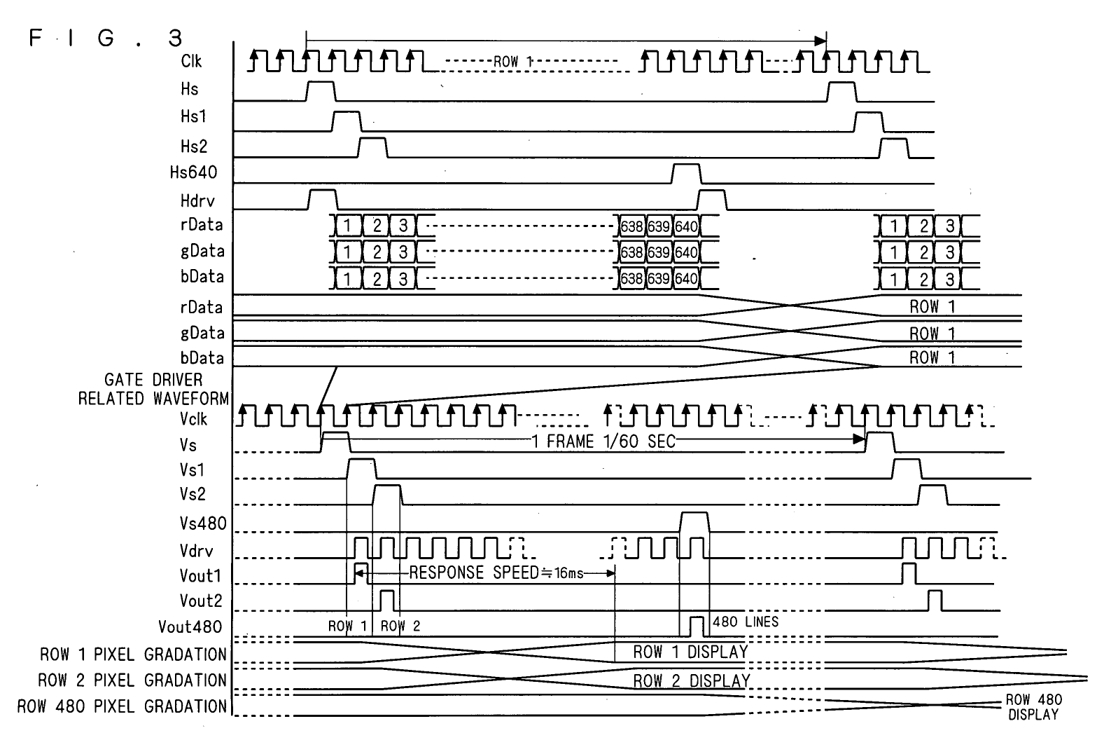

FIG. 3 is a timing diagram of signal waveform during operation of source driver 3 and gate driver 4 for composing an image writing driver.

As shown in FIG. 2, the gate driver 4 has 480 stages of shift register circuits (D flip-flops FF1 to FF480) corresponding to the number of rows of pixels arranged in an array in the liquid crystal panel 5, and AND gate group (AND gates AG1 to AG480) corresponding to their outputs.

Outputs of AND gates AG1 to AG480 are connected to gate signal wirings L1 to L480 of corresponding rows of liquid crystal panel 5, and are further connected to gate terminals of MOS transistor QE connected to the wirings by way of them.

To input terminal at one side of AND gate AGi (i=1 to 480), output signal of corresponding D flip-flops FFi is given, and other input terminal is connected to one common signal line 45, and the common signal line 45 is connected to Vclk terminal 47 for receiving vertical drive signal Vdrv.

Source wiring 50 of each column of liquid crystal panel 5 is wired to each output terminal of corresponding D/A converter 31 of source driver 3 in each one of R, G, B. Vertical transfer clock Vclk is generated by matching with the period of source driver 3 taking in the pixel data of one row.

When the source driver 3 begins to take in image data of first row, vertical start signal Vs of portion of one Vclk period is first applied to Vs terminal 46 of gate driver 4. It is synchronized with next vertical transfer clock Vclk, and taken into D input of D flip-flop FF1 of shift register corresponding to pixel of first row, and issued from Q output. At this time, image data of first line begins to be issued in batch from the source driver 3.

At the timing of analog image data from the source driver 3 synchronizing with rising (falling) sufficiently, vertical drive signal Vdrv is applied, and applied to gate wiring L1 of first row through AND gate AG1 of first row.

Consequently, MOS transistors QE corresponding to pixels of first row are turned on in batch, and analog image data signals issued to source wiring 50 (rData 1, gData 1, bData 1 to rData 640, gData 640, bData 640) are applied in batch to liquid crystal electrode of liquid crystal capacitors CE of pixels of first row through the MOS transistors QE, and then along with fall of vertical drive signal Vdrv, the MOS transistors QE are turned off, and the electric charge on the basis of the applied voltage is held in the liquid crystal capacitor CE. The counter electrode opposed to the liquid crystal electrode of liquid crystal capacitor CE is set at common voltage VC.

Thereafter, similarly, by entering vertical transfer clock Vclk and vertical drive signal Vdrv sequentially 480 times, vertical start signal Vs can be held at desired voltage (charge) in liquid crystal capacitors CE of all 480 rows, on the basis of vertical start signals Vs1, Vs2, . . . , Vs480 generated sequentially by delay of portion of one vertical transfer clock Vclk by way of D flip-flops FF1 to FF480.

As known from FIG. 3, the gate driver 4 feeds clock 480 times, and writes image data in all rows, but evidently the source driver 3 must take in data of 640 columns×3 colors within the time of one row, and issue in batch.

Therefore, depending on the panel size of liquid crystal panel 5, for displaying data of the portion of one frame, the clock of gate driver 4 requires the transfer rate of about 1000 times of frame frequency, and the source driver 3 requires the transfer rate of its 1000 times further, and therefore in the signal input to the source driver 3, it is an important technical point that the transfer clock Clk of very high speed of a level of about tens of MHz to hundreds of MHz should be finally required.

In FIG. 3, horizontal start signals Hs1, Hs2, . . . , Hs640 are signals generated by delaying horizontal start signal Hs by the portion of one transfer clock Clk sequentially by way of shift registers of 640 stages directly (equivalent to D flip-flops FF1 to FF480 of gate driver 4).

On the other hand, as shown in FIG. 3, from the time of application of vertical drive signal Vdrv, the time until settling at target transmissivity defined by image data after charging of liquid crystal capacitor CE of the capacitor enclosed by liquid crystal, and moving of crystal of the enclosed liquid crystal to change in angle of polarization is said to be response speed (of writing), and it is shorter than 10 ms at most, or generally about 20 ms to 40 ms. In FIG. 3, an example of 16 ms is shown.

Considering that the television broadcast displays 60 frames per second, the speed is 16.7 ms per frame, but the response speed is about the period of frame, or slower, and it means that desired color gradation is not obtained until next image is displayed, thereby forcing the next image to be displayed before it is ready.

It is one of the causes of blurry contour of moving picture while displaying moving image in liquid crystal. In other words, slow writing response speed is one of the problems of the present invention. The present invention is supposed to increase the write response time to a high level of 8 ms.

However, starting time of liquid crystal of each line (that is, writing start time) is deviated in each line, and the time of almost one frame is spent from start of writing the first line (row) till end of writing the final line (row). Hence, even if the write response time Tw is merely shortened, evidently, the moment of converging on target transmissivity in all pixels on the screen is impossible to achieve at the present level of operating speed (the operation period is nearly equal to the frame period).

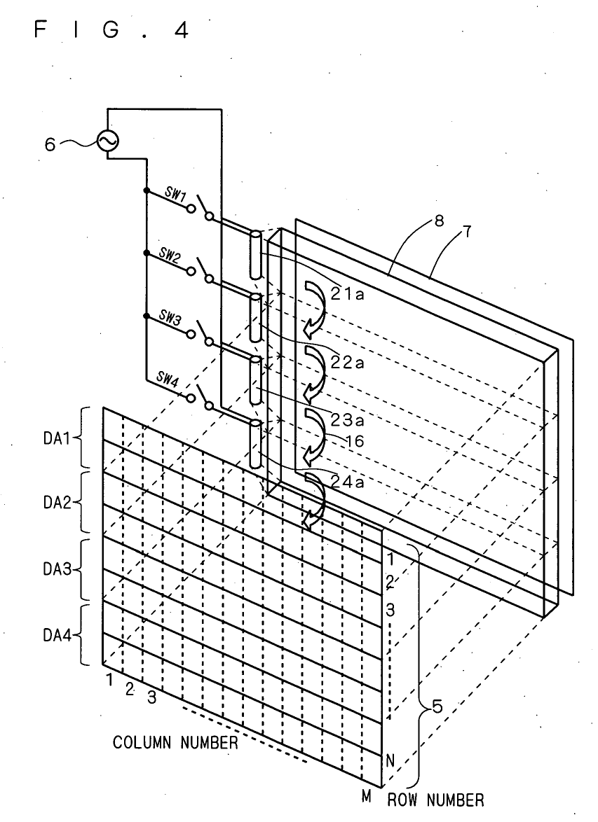

(Structure of Backlight) FIG. 4 is an explanatory diagram of backlight of liquid crystal display device in the first embodiment. As shown in the diagram, the transmission type liquid crystal panel 5 is composed of pixels of M columns×N rows. Actually, since one pixel is composed of three color pixels, red (R), green (G), and blue (B), it is composed of color pixels of M columns×3 colors×N rows. In the general structure shown in FIG. 1 to FIG. 3, the pixel composition is shown in an example of M=640 and N=480.

On the back side of the liquid crystal panel 5, a light guide plate 8 is adhered, and a reflector plate 7 is adhered to its back side.

The light guide plate 8 diffuses the light from the side (left side in FIG. 4) and guides to the side (front and rear sides) contacting with the liquid crystal panel 5, and does not so reflect to the opposite side (vertical direction in this case) direction.

In the embodiment, the liquid crystal panel 5 is divided into four regions DA1 to DA4 in the vertical direction (column direction) of the same direction as the ascending order of row numbers of data writing, and corresponding to these divided regions DA1 to DA4, four ray emission light sources 21a to 24a composed of fluorescent lamps are arranged vertically at one side (left side) of the light guide plate 8. That is, in a plan view from above the display surface of liquid crystal panel 5, ray emission light sources 21a to 24a are disposed at the side position of the display screen.

As a result, the backlight means (a plurality of divided backlight means) composed of ray emission light sources 21a to 24a, reflector plate 7, and light guide plate 8 is composed to diffuse and illuminate as uniformly as possible on the front side contacting with corresponding four divided regions DA1 to DA4 in the liquid crystal panel 5.

That is, the light emitted from the ray emission light source 21a illuminates the divided region DA1, the light emitted from the ray emission light source 22a illuminates the divided region DA2, the light emitted from the ray emission light source 23a illuminates the divided region DA3, and the light emitted from the ray emission light source 24a illuminates the divided region DA4.

Corresponding to the ray emission light sources 21a to 24a, one end each of switches SW1 to SW4 is connected, and other end of switches SW1 to SW4 is connected commonly to the backlight power source 6. That is, by turning on and off the switches SW1 to SW4, the ray emission light sources 21a to 24a can be lit and put out independently. The on/off control of switches SW1 to SW4 is operated by backlight driving circuits 11 to 14 not shown in FIG. 4.

In the first embodiment, the four divided regions DA1 to DA4 of the screen divided in vertical direction in the liquid crystal panel 5 are designed to light up and put out the backlight independently by ray emission light sources 21a to 24a by turning on and off the switches SW1 to SW4.

(Light Guide Plate)

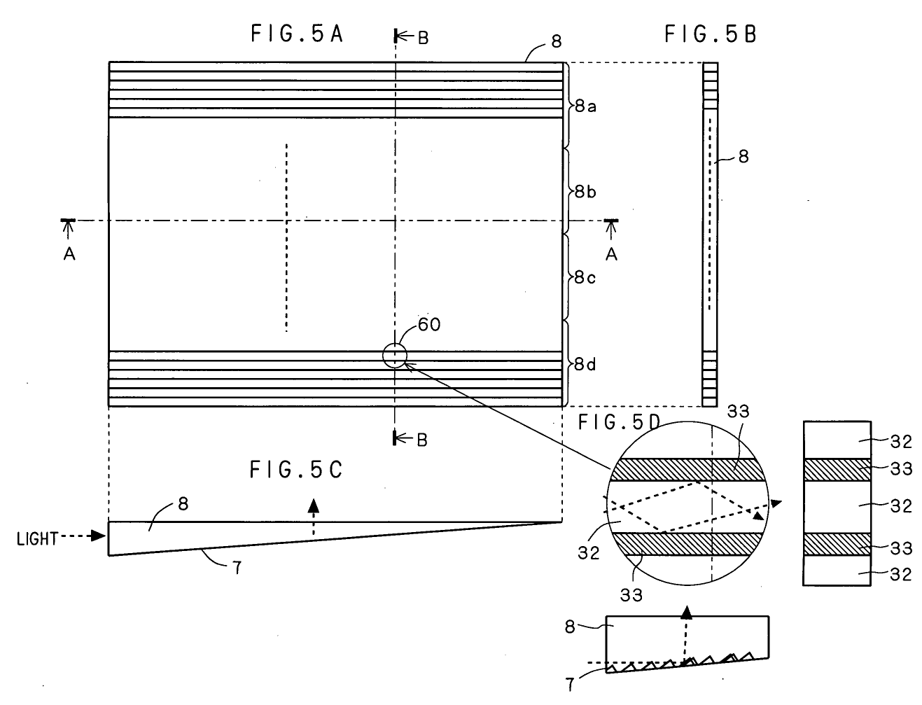

FIGS. 5A-5D are explanatory diagrams of a structure of light guide plate 8 in the first embodiment. In the diagram, FIG. 5A is a front view seen from the side of liquid crystal panel 5, FIGS. 5B and 5C are B-B section view and A-A section view of FIG. 5A respectively, and FIG. 5D is a magnified view (front view, sectional view) of region 60 in FIG. 5A.

As shown in FIG. 5A, the light guide plate 8 is divided into four partial light guide sections 8a to 8d, corresponding to ray emission light sources 21a to 24a and divided regions DA1 to DA4.

As shown in FIG. 5C, the entire light guide plate 8 has substantially a triangular sectional shape, and the back side forms a reflector plate 7 having a reflection surface (mirror surface) of sawtooth section, and the light from the lateral side is reflected to the front side.

As shown in FIG. 5D, as seen from the front side (from the liquid crystal panel 5), a low refraction region 32 and a high refraction region 33 are alternately formed in layers in vertical direction (column direction), and these regions 32 and 33 are formed to extend in the lateral direction (row direction). The refractive indices of low refraction region 32 and high refraction region 33 are in relative relation, and the refractive index is only set relatively higher in high refraction region 33 than in low high refraction region 32. The structure of partial light guide sections 8a to 8d is shown in FIG. 5D.

As mentioned above, the partial light guide sections 8a to 8d have light shielding structure forming low refraction region 32 and high refraction region 33 alternately, and the light entering the light guide plate 8 from the left side is reflected by the high refraction region 33, and is entrapped in the low refraction region 32, and is thus guided almost only in the lateral direction (row direction) as seen from the front side. In the structure (example 1) of the light guide plate 8 shown in FIGS. 5A-5D, four divided backlight means are composed of the ray emission light sources 21a to 24a, partial light guide sections 8a to 8d, and its back reflector plate 7. The light shielding structure is, for example relating to partial light guide section 8b, designed to reduce the quantity of light leaking to the partial light guide sections 8a, 8c, 8d to ⅓ or less of the total quantity of light emitted from a specified light source, that is, ray emission light source 21b.

The incident light from the ray emission light sources 21a to 24a is guided in the lateral direction (row direction), and is reflected by the mirror surface of reflector plate 7 having a sawtooth section formed in the oblique bottom, and is reflected to the front direction. As a result, the light entering from the side does not diffuse in the vertical direction (column direction), but is almost completely guided precisely into the front side of determined region. That is, the incident light from the ray emission light source 21a illuminates the divided region DA1 by way of the partial light guide section 8a, the incident light from the ray emission light source 22a illuminates the divided region DA2 by way of the partial light guide section 8b, the incident light from the ray emission light source 23a illuminates the divided region DA3 by way of the partial light guide section 8c, and the incident light from the ray emission light source 24a illuminates the divided region DA4 by way of the partial light guide section 8d.

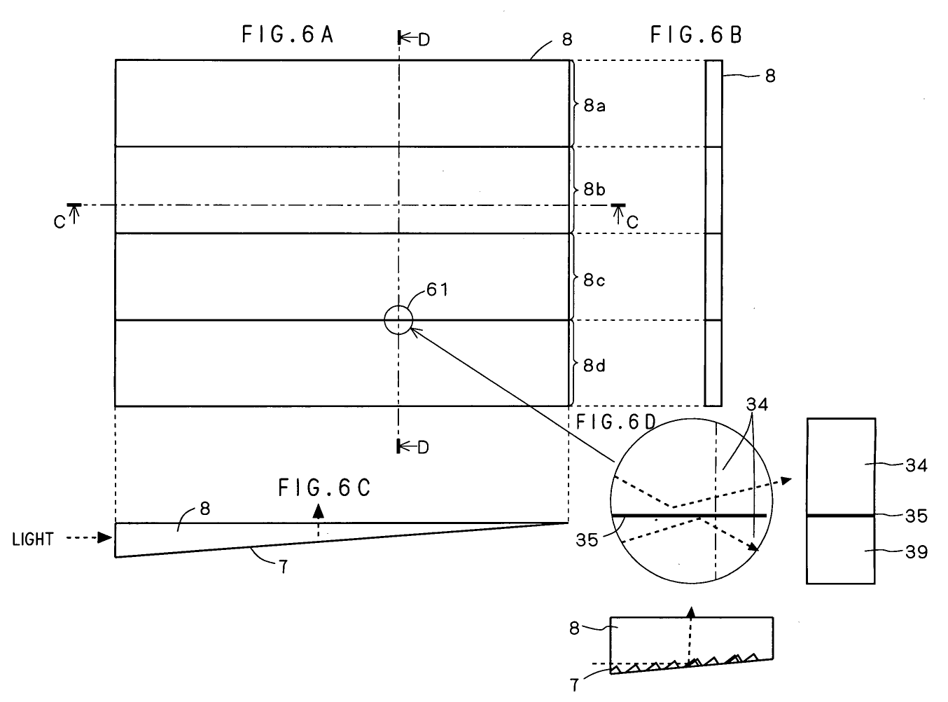

FIGS. 6A-6D are explanatory diagrams of other structure of light guide plate 8 in the first embodiment. In the diagram, FIG. 6A is a front view seen from the side of liquid crystal panel 5, FIGS. 6B and 6C are D-D section view and C-C section view of FIG. 6A respectively, and FIG. 6D is a magnified view (front view, sectional view) of region 61 in FIG. 6A.

In the examples in FIGS. 6A-6D, the light guide plate 8 is divided into four partial light guide sections 8a to 8d, and the entire light guide plate 8 has substantially a triangular sectional shape (see FIG. 6C in the diagram) consisting of four partial light guide sections 8a to 8d bonded together vertically as seen from the front side. The partial light guide sections 8a to 8d of the light guide plate 8 are formed of light permeable regions 34, and the upper and lower sides as seen from the front side (boundary sides between partial light guide sections 8a and 8b, 8b and 8c, and 8c and 8d) are both-side mirror boundary parts 35 having mirror surface on both sides, and the back side is a reflector plate 7 having a reflection surface (mirror surface) of sawtooth section, so that the light from the lateral side is reflected to the front side. In the structure (second example) of the light guide plate 8 shown in FIGS. 6A-6D, four divided backlight means are composed of ray emission light sources 21a to 24a, partial light guide sections 8a to 8d, and back side reflector plate 7.

In this configuration, the light does not transmit through four partial light guide sections 8a to 8d having both-side mirror boundary parts 35 functioning as light shielding structure, and four regions are independently controlled to light up (emission) and put out (off). As a result, the incident light from the ray emission light source 21a illuminates the divided region DA1 by way of the partial light guide section 8a, the incident light from the ray emission light source 22a illuminates the divided region DA2 by way of the partial light guide section 8b, the incident light from the ray emission light source 23a illuminates the divided region DA3 by way of the partial light guide section 8c, and the incident light from the ray emission light source 24a illuminates the divided region DA4 by way of the partial light guide section 8d. The light shielding structure is, for example relating to partial light guide section 8b, designed to reduce the quantity of light leaking to the partial light guide sections 8a, 8c, 8d to ⅓ or less of the total quantity of light emitted from a specified light source, that is, ray emission light source 21b.

If, meanwhile, the light guided in the lateral direction can be reflected to the front direction by the sawtooth section of the reflector plate 7 only, the A-A section in FIG. 5A and C-C section in FIG. 6A can be formed in rectangular shape.

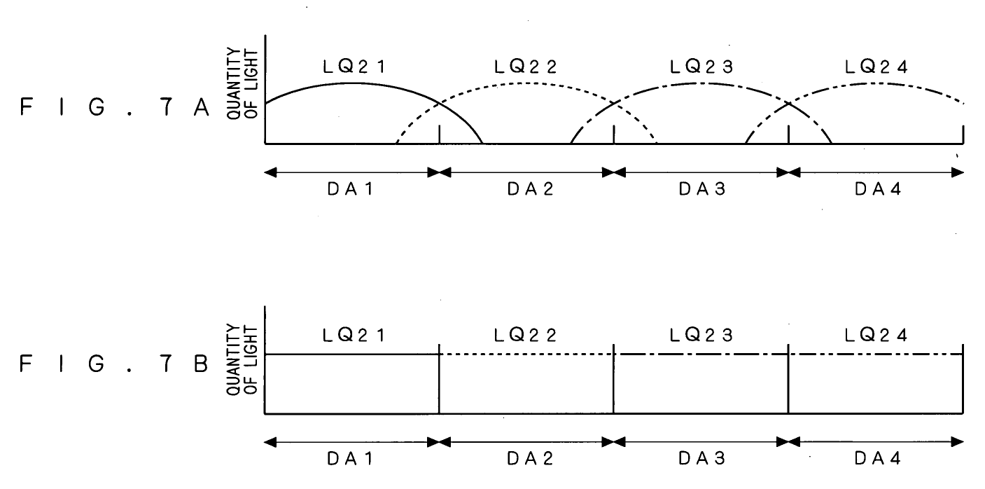

FIGS. 7A and 7B are explanatory diagrams of light illumination distribution divided by the divided regions DA1 to DA4. In this embodiment, the light source is divided and assigned to illuminate the divided regions DA1 to DA4.

FIG. 7A shows the quantity of light LQ21 to LA24 of each region when the light source is roughly assigned, and FIG. 7B shows the same when the light source is completely divided, schematically in each light source. In FIGS. 7A and 7B, the X-axis shows the position in the vertical direction of the panel as seen from the front side, and the Y-axis denotes the quantity of light.

FIG. 7B shows light emitted from the light source completely divided and assigned in the divided regions DA1 to DA4, but shows the light is leaking between adjacent divided regions in FIG. 7A (that is, between DA1 and DA2, DA2 and DA3, and DA3 and DA4). In both cases FIGS. 7A and 7B, the effect of the embodiment can be expressed sufficiently. However, from the viewpoint of improvement of precision of moving image display, the completely divided state in FIG. 7B is more preferable.

(Control Operation)

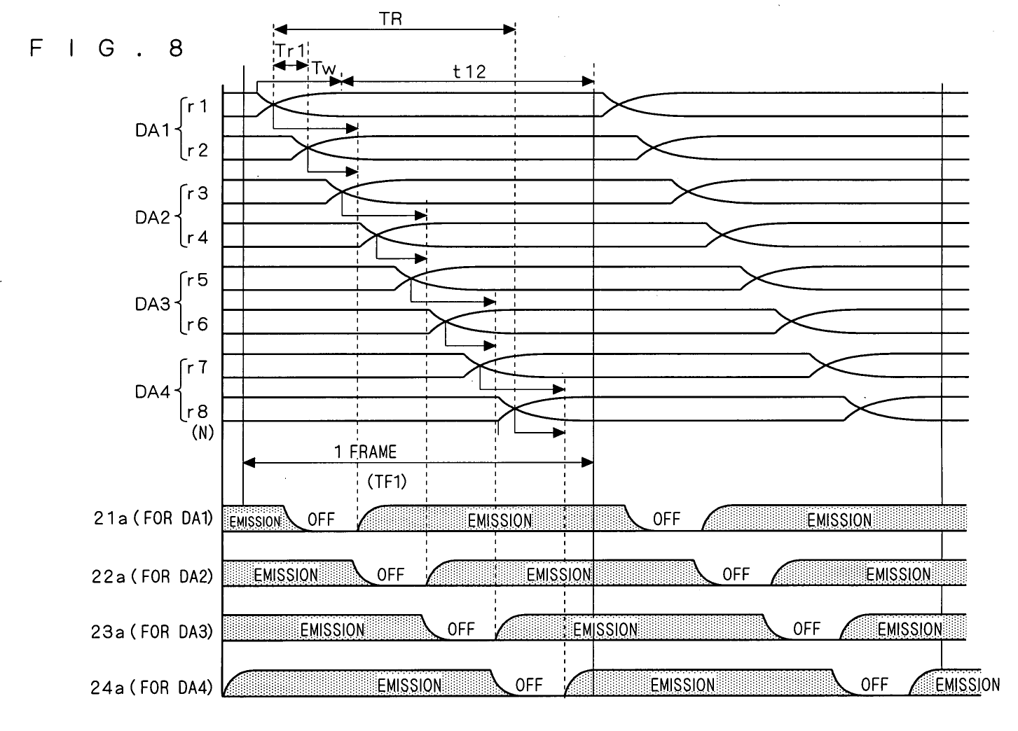

FIG. 8 is a timing chart showing the timing relation of writing of data and backlight on/off in divided regions DA1 to DA4 in the embodiment. In the diagram, for the sake of explanation, the divided regions DA1 to DA4 are shown to display two rows each, that is, N=8. The diagram shows the light emission/off operation by divided backlights 21 to 24 corresponding to divided regions DA1 to DA4. In the first embodiment, the divided backlights 21 to 24 correspond to ray emission light sources 21a to 24a.

As shown in the diagram, in the period of one frame TF1, write delay time TR and write response time Tw occur between row r1 and row r8.

In this embodiment, by dividing the region of liquid crystal panel 5 into four regions vertically, in divided region DA1, for example, time difference Tr1 between row r1 to be written first in divided region DA1 and row r2 to be written finally is curtailed to about ¼ (about ¼ frame period) as compared with delay time TR of the prior art.

Therefore, in the case of liquid crystal panel 5 of write response time Tw (about 8 ms) of ½ frame period, in divided region DA1, there is enough time for all pixels to settle at target transmissivity in a period of about ¼ frame period (={1−¼(Tr1)−½(Tw)}).

In the embodiment, only in a specific time including the time of all pixels settling at target transmissivity, the ray emission light sources for illuminating the corresponding divided regions are lit up (light-emitted). In the example in FIG. 8, the ray emission light source 21a is lit up (light-emitted) in period t12 in which rows r1 and r2 in divided region DA1 are settling at target transmissivity.

Such illumination on/off display is executed repeatedly in sequence in divided regions DA1 to DA4 as shown in FIG. 8, so that impulse type emission display can be realized.

(Backlight On/Off Control Unit)

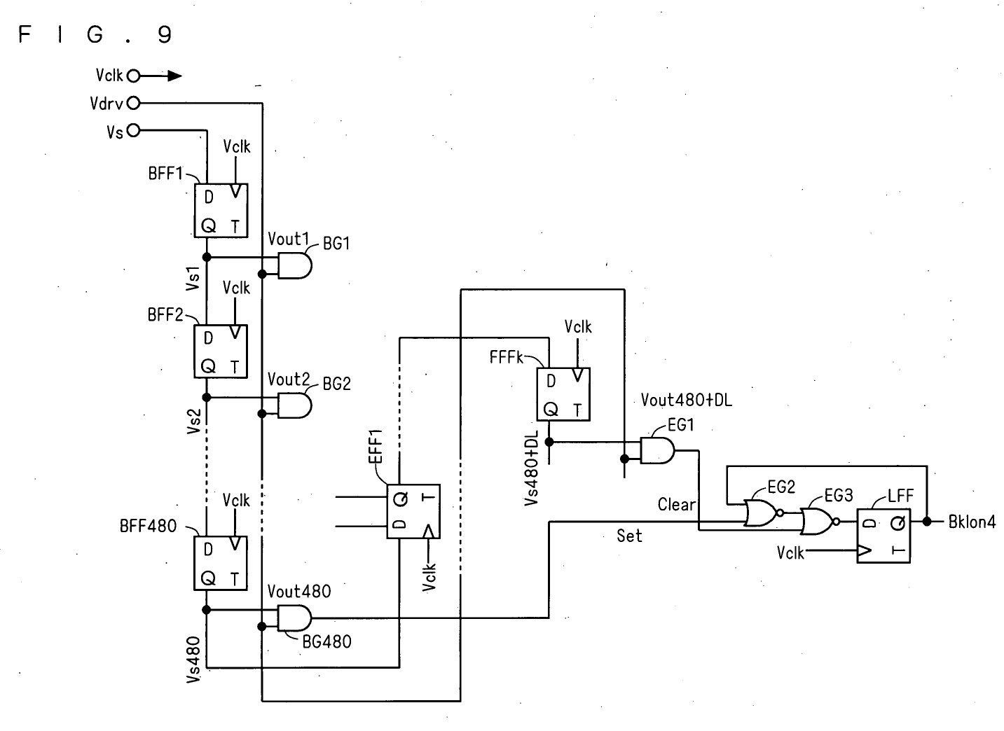

FIG. 9 is a circuit diagram of backlight on/off control unit in the timing controller 2. As shown in the diagram, the backlight on/off control unit consists of 480 stages of series-connected D flip-flops BFF1 to BFF480, 480 AND gates BG1 to BG480, k stages of series-connected D flip-flops EFF1 to EFFk, AND gate EG1, NOR gates EG2, EG3, and D flip-flop LFF.

The D flip-flops BFF1 to BFF480 commonly receive vertical transfer clock Vclk in the clock input, and vertical start signal Vs is received in D input of first stage D flip-flop BFF1, and Q outputs of D flip-flops BFF1 to BFF480 are connected to one input of AND gates BG1 to BG480. In other input of AND gates BG1 to BG480, vertical drive signal Vdrv is commonly applied. Output signal Vout480 of AND gate BG480 becomes a set signal Set for instructing start of illumination of divided region DA4.

The D flip-flops EFF1 to EFFk commonly receive vertical transfer clock Vclk in the clock input, and Q output (Vs480) of D flip-flop BFF480 is connected to D input of first stage D flip-flop EFF1. Then Q output of D flip-flop EFFk becomes one input of AND gate EG1. The AND gate EG1 receives vertical drive signal Vdrv as other input. The output signal (Vs480+DL) of AND gate EG1 becomes a clear signal Clear for instructing end of illumination.

The NOR gate EG2 receives the Q output of D flip-flop LFF in one input, and receives set signal Set in other input. The NOR gate EG3 receives the output of NOR gate EG2 in one input, and receives clear signal Clear in other input. The D flip-flop LFF receives the output of NOR gate EG3 in D input, and receives vertical transfer clock Vclk in clock input, and the D output becomes a backlight division control signal Bklon4 for backlight driving circuit 14.

The backlight division control signal Bklon4 is a signal rising to “H” in synchronism with rise of set signal Set to “H”, and falling to “L” in synchronism with rise of clear signal Clear to “H”. The rising timing of set signal Set to “H” is the timing of the Q output of D flip-flop BFF480 to become “H”, and the rising timing of clear signal Clear to “H” is the timing of the Q output of D flip-flop BFF480 becoming “H” in delay time DL of propagation of D flip-flops EFF1 to EFFk from rise to “H” (equivalent to period of k×(cycle of Vclk)).

Therefore, the backlight division control signal Bklon4 becomes “H” for instructing emission in one vertical transfer clock Vclk after “H” of set signal Set, and then after delay time DL, it is changed to “L” for instructing to put out (off). As a result, by properly setting the delay time DL, the backlight division control signal Bklon4 for turning on or off the ray emission light source 24a in FIG. 8 can be issued to the backlight driving circuit 14.

The backlight division control signal Bklon1 to Bklon3 are not shown, but can be realized same as the backlight division control signal Bklon4 by generating signals corresponding to set signal Set and clear signal Clear, on the basis of outputs Vout120, Vout240, and Vout 360 of AND gates BG120, BF240, and BG360, and delay signals (Vs120+DL), (Vs240+DL), and (Vs360+DL) of outputs of D flip-flops BFF120, BFF240, and BFF360.

(Effects)

The liquid crystal display device of the first embodiment has the structure as mentioned above, and the backlight lighting is controlled as shown in FIG. 8 so as to conform to image data writing having write response time Tw. As a result, although not possible in the prior art, it is possible to obtain a time zone capable of achieving the target transmissivity in all pixels of divided region DA corresponding to lighting of the backlight which is lit (emission) and put out (off), even in the write response time Tw (about 8 ms) similar to conventional performance, and hence the operation and display performance of impulse type display system can be enhanced.

In addition, by dividing and disposing the ray emission light sources 21a to 24a vertically at the left side (or right side), increase in thickness of liquid crystal module composed of liquid crystal panel 5 and backlight means can be avoided, and the device can be easily reduced in size.

Since ray emission light sources such as fluorescent lamps are used as light sources, backlight illumination can be realized relatively at low cost.

Therefore, the liquid crystal display device of the embodiment can be applied in thin type notebook personal computer, cellphone, and portable TV/DVD display device and the like.

In the first embodiment, by controlling the backlight driving circuits 11 to 14 by the timing controller 2, the circuit configuration of liquid crystal panel 5 can be realized only by adding and changing the backlight circuit system, and changes around the source driver 3 and gate driver 4 can be limited to a minimum.

### Second Embodiment

(Entire Configuration)

In the liquid crystal display device in a second embodiment, the entire configuration is same as in the first embodiment shown in FIG. 1 to FIG. 3.

(Structure of Backlight)

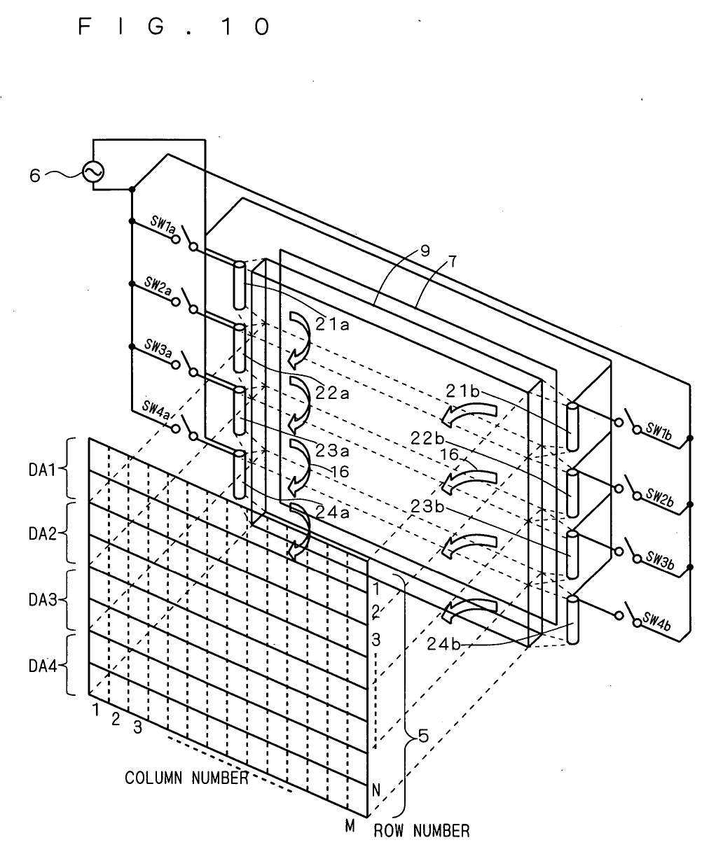

FIG. 10 is an explanatory diagram of backlight of liquid crystal display device in the second embodiment. As shown in the diagram, the transmission type liquid crystal panel 5 is composed of pixels of M columns×N rows same as in the first embodiment.

On the back side of the liquid crystal panel 5, a light guide plate 9 is adhered, and a reflector plate 7 is adhered to its back side. The light guide plate 9 diffuses, same as the light guide plate 8 in the first embodiment, the light from the side (right and left sides in FIG. 10) and guides to the side (front and rear sides) contacting with the liquid crystal module, and does not so reflect to the opposite side (vertical direction in this case) direction.

In the second embodiment, too, in the same manner as in the first embodiment, the liquid crystal panel 5 is divided into four divided regions DA1 to DA4, and corresponding to these divided regions DA1 to DA4, four ray emission light sources 21a to 24a and ray emission light sources 21b to 24b formed of fluorescent lamps are disposed vertically each at both sides of light guide plate 9 (right and left sides; both sides of liquid crystal panel 5 in plan view as seen from the front side of liquid crystal panel). As a result, the backlight means composed of ray emission light sources 21a to 24a, ray emission light sources 21b to 24b, reflector plate 7, and light guide plate 9 is composed to diffuse and illuminate as uniformly as possible on the front side contacting with corresponding four divided regions DA1 to DA4 in the liquid crystal panel 5.

That is, the light emitted from the ray emission light sources 21a, 21b illuminates the divided region DA1, the light emitted from the ray emission light sources 22a, 22b illuminates the divided region DA2, the light emitted from the ray emission light sources 23a, 23b illuminates the divided region DA3, and the light emitted from the ray emission light sources 24a, 24b illuminates the divided region DA4.

Corresponding to the ray emission light sources 21a to 24a, one end each of switches SW1a to SW4a is connected, corresponding to the ray emission light sources 21b to 24b, one end each of switches SW1b to SW4b is connected, and other end of switches SW1a to SW4a, and switches SW1b to SW4b is connected commonly to the backlight power source 6. That is, by turning on and off the switches SW1a to SW4a and switches SW1b to SW4b, the ray emission light sources 21a to 24a, and ray emission light sources 21b to 24b are designed to light up and put out independently. The on/off control of switches SW1a to SW4a and switches SW1b to SW4b, is operated by backlight driving circuits 11 to 14 not shown in FIG. 10.

In the second embodiment, the four divided regions DA1 to DA4 of the screen divided in vertical direction in the liquid crystal panel 5 are designed to light up and put out the backlight independently by ray emission light sources 21a to 24a and ray emission light sources 21b to 24b by turning on and off the switches SW1a to SW4a and switches SW1b to SW4b.

(Light Guide Plate)

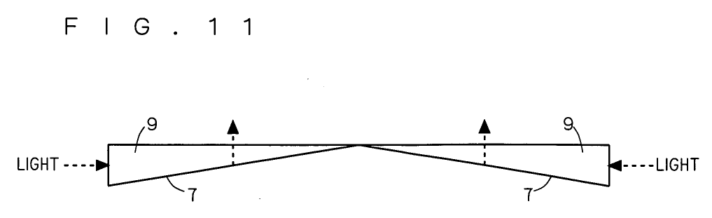

FIG. 11 is an explanatory diagram of a structure of light guide plate 9 in the second embodiment. FIG. 11 corresponds to A-A section of reflector plate 7 shown in FIG. 5, or C-C section of reflector plate 7 shown in FIG. 6.

As shown in the diagram, the entire light guide plate 9 has two triangular sections having the right and left sides as the bottom, and the central part as the peak, and the back side forms a reflector plate 7 having a reflection surface (not shown in FIG. 11) of sawtooth section, and the light from the right and left is reflected to the front side. The other structure is same as the reflector plate 7 shown in FIGS. 5A-5D or FIGS. 6A-6D. If, meanwhile, the light guided from the right and left can be reflected to the front direction by the sawtooth section (see FIGS. 5D and 6D) of the reflector plate 7 only, the section in FIG. 11 can be formed in rectangular shape.

In this structure, light does not transmit through four regions 8a to 8d, and hence four regions can be independently controlled to light up and put out.

(Control Operation)

Control operation of liquid crystal display device in the second embodiment is same as the control operation in the first embodiment shown in FIG. 8. In the second embodiment, divided backlights 21 to 24 correspond to ray emission light sources 21a to 24a, and ray emission light sources 21b to 24b.

(Backlight On/Off Control Unit)

The backlight on/off control unit in the second embodiment is realized by the same structure as in the first embodiment shown in FIG. 9 provided in the timing controller 2.

(Effects)

The liquid crystal display device of the second embodiment has the structure as mentioned above, and in the same manner as in the first embodiment, it is possible to obtain a time zone capable of achieving the target transmissivity in all pixels of divided region DA corresponding to lighting of the backlight which is lit (emission) and put out (off), even in the write response time Tw similar to conventional performance.

In addition, by dividing and disposing the ray emission light sources 21a to 24a and ray emission light sources 21b to 24b vertically at both sides the light guide plate 9, increase in thickness of liquid crystal module of transmission type can be avoided, and the device can be easily reduced in size same as in the first embodiment.

Further, in the second embodiment, as compared with the first embodiment having ray emission light sources 21a to 24a disposed at one side of light guide plate, effects can be advantageously presented at double brightness.

As a result, it can be applied in thin type notebook personal computer, cellphone, and portable TV/DVD display device and the like, and it is also effective to enhance the brightness. Depending on the case, it seems to contribute to reduction of thickness of stationary type TV broadcast display device and the like.

### Third Embodiment

(Entire Configuration)

In the liquid crystal display device in a third embodiment, the entire configuration is same as in the first embodiment shown in FIG. 1 to FIG. 3.

(Structure of Backlight)

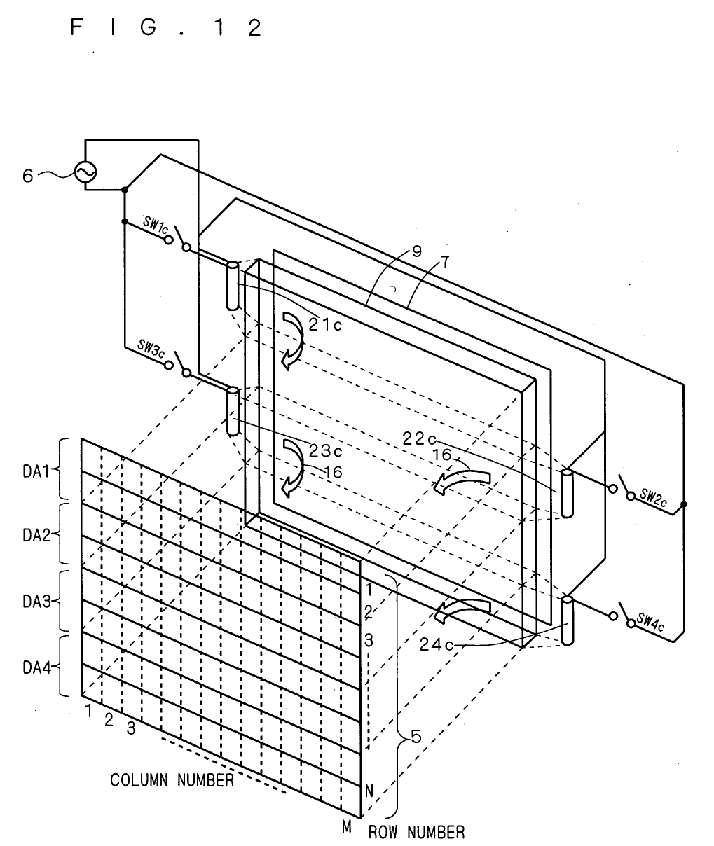

FIG. 12 is an explanatory diagram of backlight of liquid crystal display device in the third embodiment. As shown in the diagram, the transmission type liquid crystal panel 5 is composed of pixels of M columns×N rows same as in the first embodiment.

On the back side of the liquid crystal panel 5, a light guide plate 9 is adhered same as in the second embodiment, and a reflector plate 7 is adhered to its back side.

In the third embodiment, too, in the same manner as in the first embodiment, the liquid crystal panel 5 is divided into four divided regions DA1 to DA4, and corresponding to these divided regions DA1 to DA4, four ray emission light sources 21c to 24c formed of fluorescent lamps are disposed vertically each at both sides of light guide plate 9 (right and left sides; both sides of liquid crystal panel 5 in plan view as seen from the front side of liquid crystal panel). That is, in FIG. 12, the ray emission light source 21c and ray emission light source 23c are disposed at the left side, and the ray emission light source 22c and ray emission light source 24c are disposed at the right side.

As a result, the backlight means composed of ray emission light sources 21c to 24c, reflector plate 7, and light guide plate 9 is composed to diffuse and illuminate as uniformly as possible on the front side contacting with corresponding four divided regions DA1 to DA4 in the liquid crystal panel 5.

That is, the light emitted from the ray emission light source 21c illuminates the divided region DA1, the light emitted from the ray emission light source 22c illuminates the divided region DA2, the light emitted from the ray emission light source 23c illuminates the divided region DA3, and the light emitted from the ray emission light source 24c illuminates the divided region DA4.

Corresponding to the ray emission light sources 21c to 24c, one end each of switches SW1c to SW4c is connected, and other end of switches SW1c to SW4c is connected commonly to the backlight power source 6. That is, by turning on and off the switches SW1c to SW4c, the ray emission light sources 21c to 24c are designed to light up and put out independently. The on/off control of switches SW1c to SW4c is operated by backlight driving circuits 11 to 14 not shown in FIG. 12.

In the third embodiment, the four divided regions DA1 to DA4 of the screen divided in vertical direction in the liquid crystal panel 5 are designed to light up and put out the backlight independently by ray emission light sources 21c to 24c by turning on and off the switches SW1c to SW4c.

(Light Guide Plate)

The light guide plate 9 in the third embodiment is similar to that of the second embodiment, except that the sectional structure of divided regions DA2 and DA4 is inverted laterally.

(Control Operation)

Control operation of liquid crystal display device in the third embodiment is same as the control operation in the first embodiment shown in FIG. 8. In the third embodiment, divided backlights 21 to 24 correspond to ray emission light sources 21c to 24c.

(Backlight On/Off Control Unit)

The backlight on/off control unit in the third embodiment is realized by the same structure as in the first embodiment shown in FIG. 9 provided in the timing controller 2.

(Effects)

The liquid crystal display device of the third embodiment has the structure as mentioned above, and in the same manner as in the first embodiment, it is possible to obtain a time zone capable of achieving the target transmissivity in all pixels of divided region DA corresponding to lighting of the backlight which is lit and put out, even in the write response time Tw similar to conventional performance.

In addition, by dividing and disposing the ray emission light sources 21c to 24c vertically at one side the light guide plate 9, increase in thickness of liquid crystal module of transmission type can be avoided, and the device can be thus easily reduced in size same as in the first embodiment.

Further, by dispersed disposing ray emission light sources 21c and 23c out of four ray emission light sources 21c to 24c, at the left side of the light guide plate 9, and ray emission light sources 22c and 24c at the right side of the light guide plate 9 by two ray emission light sources, heat generation is not concentrated at one side, and as compared with the vertical layout of four ray emission light sources 21a to 24a, etc. as in the first embodiment and the second embodiment, physical space for disposing is assured, and seamless vertical light emission is realized.

As a result, it can be applied in thin type notebook personal computer, cellphone, and portable TV/DVD display device and the like, and it is also effective to make the housing design easier by scattering heat generation by illumination of ray emission light sources without concentrating at one side of light guide plate 9.

### Fourth Embodiment

(Entire Configuration)

In the liquid crystal display device in a fourth embodiment, the entire configuration is same as in the first embodiment shown in FIG. 1 to FIG. 3.

(Structure of Backlight)

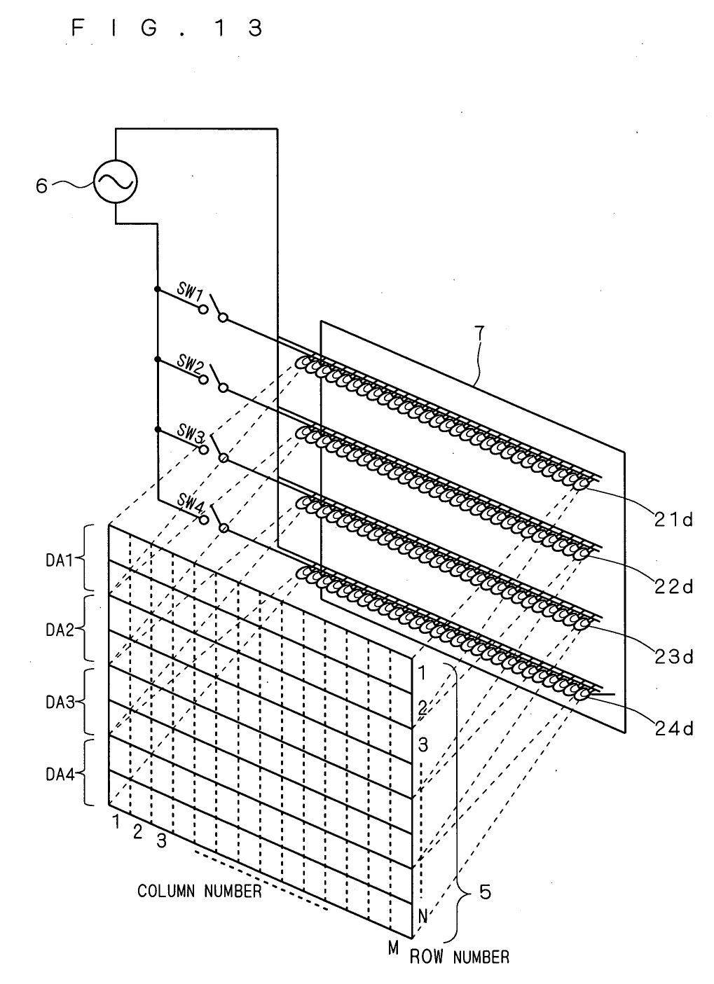

FIG. 13 is an explanatory diagram of backlight of liquid crystal display device in the fourth embodiment. As shown in the diagram, the transmission type liquid crystal panel 5 is composed of pixels of M columns×N rows same as in the first embodiment.

On the back side of the liquid crystal panel 5, four spot emission light sources (group) 21d to 24d of white LED or the like are disposed in the vertical direction of liquid crystal panel 5, and the spot emission light sources 21d to 24d are extended in the lateral direction. On the back side of the pot emission light sources 21d to 24d, a reflector plate 7 is adhered and disposed.

In the fourth embodiment, too, in the same manner as in the first embodiment, the liquid crystal panel 5 is divided into four divided regions DA1 to DA4, and corresponding to these divided regions DA1 to DA4, spot emission light sources 21d to 24d are disposed. That is, in FIG. 13, the spot emission light sources 21d to 24d are disposed on the back side of divided regions DA1 to DA4 of liquid crystal panel 5.

As a result, the backlight means composed of spot emission light sources 21d to 24d and reflector plate 7 is composed to diffuse and illuminate as uniformly as possible on the front side contacting with corresponding four divided regions DA1 to DA4 in the liquid crystal panel 5.

That is, the light emitted from the spot emission light source 21d illuminates the divided region DA1, the light emitted from the spot emission light source 22d illuminates the divided region DA2, the light emitted from the spot emission light source 23d illuminates the divided region DA3, and the light emitted from the spot emission light source 24d illuminates the divided region DA4.

In FIG. 13, the spot emission light sources 21d to 24d are arranged in a row in lateral direction, but may be also arranged in plural rows within a same group corresponding to same divided regions, or may be arranged in an array. Anyway, the same effects are obtained as far as the four sets of white LED or other spot emission light source group respectively illuminating the four divided regions DA1 to DA4 are disposed vertically same as the divided regions DA1 to DA4.

Corresponding to the spot emission light sources 21d to 24d, one end each of switches SW1 to SW4 is connected, and other end of switches SW1 to SW4 is connected commonly to the backlight power source 6. That is, by turning on and off the switches SW1 to SW4, the spot emission light sources 21d to 24d are designed to light up and put out independently. The on/off control of switches SW1 to SW4 is operated by backlight driving circuits 11 to 14 not shown in FIG. 13.

In the fourth embodiment, the four divided regions DA1 to DA4 of the screen divided in vertical direction in the liquid crystal panel 5 are designed to light up and put out the backlight independently by spot emission light sources 21d to 24d by turning on and off the switches SW1 to SW4.

(Control Operation)

Control operation of liquid crystal display device in the fourth embodiment is same as the control operation in the first embodiment shown in FIG. 8. In the fourth embodiment, divided backlights 21 to 24 correspond to spot emission light sources 21d to 24d.

(Backlight On/Off Control Unit)

The backlight on/off control unit in the fourth embodiment is realized by the same structure as in the first embodiment shown in FIG. 9 provided in the timing controller 2.

(Effects)

The liquid crystal display device of the fourth embodiment has the structure as mentioned above, and in the same manner as in the first embodiment, it is possible to obtain a time zone capable of achieving the target transmissivity in all pixels of divided region DA corresponding to lighting of the backlight which is lit and put out, even in the write response time Tw similar to conventional performance.

In addition, by dividing and disposing the spot emission light sources 21d to 24d vertically on the back side of the liquid crystal panel 5, these effects are obtained while keeping a high brightness.

Meanwhile, from the ray emission light sources of fluorescent lamps and others used in the first embodiment to the third embodiment, by changing to white LED and other spot emission light sources, the operation life of emission light sources for lighting up (emission) and putting out (oft) can be extended. Further, response speed of lighting and extinguishing of emission light sources can be enhanced, and lighting can be controlled at smaller time intervals, and as compared with ray emission light sources, the element size can be reduced, and therefore the device can be manufactured in a further thin design while maintaining the brightness.

As a result, it can be applied in stationary type large-screen television broadcast display device and others in which luminance is very important, and further the operation life of the device can be extended.

### Fifth Embodiment

(Entire Configuration)

In the liquid crystal display device in a fifth embodiment, the entire configuration is same as in the first embodiment shown in FIG. 1 to FIG. 3.

(Structure of Backlight)

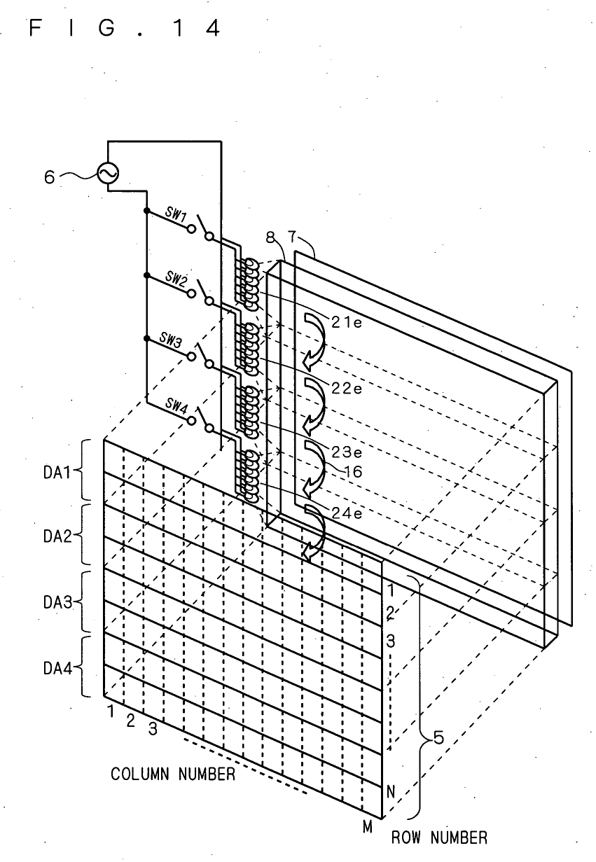

FIG. 14 is an explanatory diagram of backlight of liquid crystal display device in the fifth embodiment. As shown in the diagram, the transmission type liquid crystal panel 5 is composed of pixels of M columns×N rows same as in the first embodiment.

On the back side of the liquid crystal panel 5, a light guide plate 8 same as in the first embodiment is adhered, and a reflector plate 7 is adhered to its back side.

In the fifth embodiment, too, in the same manner as in the first embodiment, the liquid crystal panel 5 is divided into four divided regions DA1 to DA4, and corresponding to these divided regions DA1 to DA4, four spot emission light sources 21e to 24e of white LED groups are disposed vertically at the side of light guide plate 8 (left side; left side of liquid crystal panel 5 in plan view as seen from the front of the liquid crystal panel 5). As a result, the backlight means composed of spot emission light sources 21e to 24e, reflector plate 7, and light guide plate 8 is composed to diffuse and illuminate as uniformly as possible on the front side contacting with corresponding four divided regions DA1 to DA4 in the liquid crystal panel 5.

That is, the light emitted from the spot emission light source 21e illuminates the divided region DA1, the light emitted from the spot emission light source 22e illuminates the divided region DA2, the light emitted from the spot emission light source 23e illuminates the divided region DA3, and the light emitted from the spot emission light source 24e illuminates the divided region DA4.

Corresponding to the spot emission light sources 21e to 24e, one end each of switches SW1 to SW4 is connected, and other end of switches SW1 to SW4 is connected commonly to the backlight power source 6. That is, by turning on and off the switches SW1 to SW4, the spot emission light sources 21e to 24e are designed to light up and put out independently. The on/off control of switches SW1 to SW4 is operated by backlight driving circuits 11 to 14 not shown in FIG. 14.

In the fifth embodiment, the four divided regions DA1 to DA4 of the screen divided in vertical direction in the liquid crystal panel 5 are designed to light up and put out the backlight independently by spot emission light sources 21e to 24e by turning on and off the switches SW1 to SW4.

(Light Guide Plate)

The light guide plate 8 in the fifth embodiment is same as the light guide plate 8 in the first embodiment.

(Control Operation)

Control operation of liquid crystal display device in the fifth embodiment is same as the control operation in the first embodiment shown in FIG. 8. In the fifth embodiment, divided backlights 21 to 24 correspond to spot emission light sources 21e to 24e.

(Backlight On/Off Control Unit)

The backlight on/off control unit in the fifth embodiment is realized by the same structure as in the first embodiment shown in FIG. 9 provided in the timing controller 2.

(Effects)

The liquid crystal display device of the fifth embodiment has the structure as mentioned above, and in the same manner as in the first embodiment, it is possible to obtain a time zone capable of achieving the target transmissivity in all pixels of divided region DA corresponding to lighting of the backlight which is lit and put out, even in the write response time Tw similar to conventional performance.

In addition, by dividing and disposing the spot emission light sources 21e to 24e vertically at the lateral side, increase in thickness of liquid crystal module of transmission type can be avoided, and the device can be easily reduced in size same as in the first embodiment.

Moreover, in the same manner as in the fourth embodiment, by using white LED or the like as spot emission light sources for backlight illumination, the operation life of emission light sources for lighting up and putting out can be extended. Further, response speed of lighting and extinguishing of emission light sources can be enhanced, and lighting can be controlled at smaller time intervals, and as compared with ray emission light sources, the element size can be reduced, and therefore the device can be manufactured in a further thin design while maintaining the brightness.

As a result, it can be applied in stationary type large-screen television broadcast display device and others in which luminance is very important, and further the operation life of the device can be extended.

### Sixth Embodiment

(Entire Configuration)

In the liquid crystal display device in a sixth embodiment, the entire configuration is same as in the first embodiment shown in FIG. 1 to FIG. 3.

(Structure of Backlight)

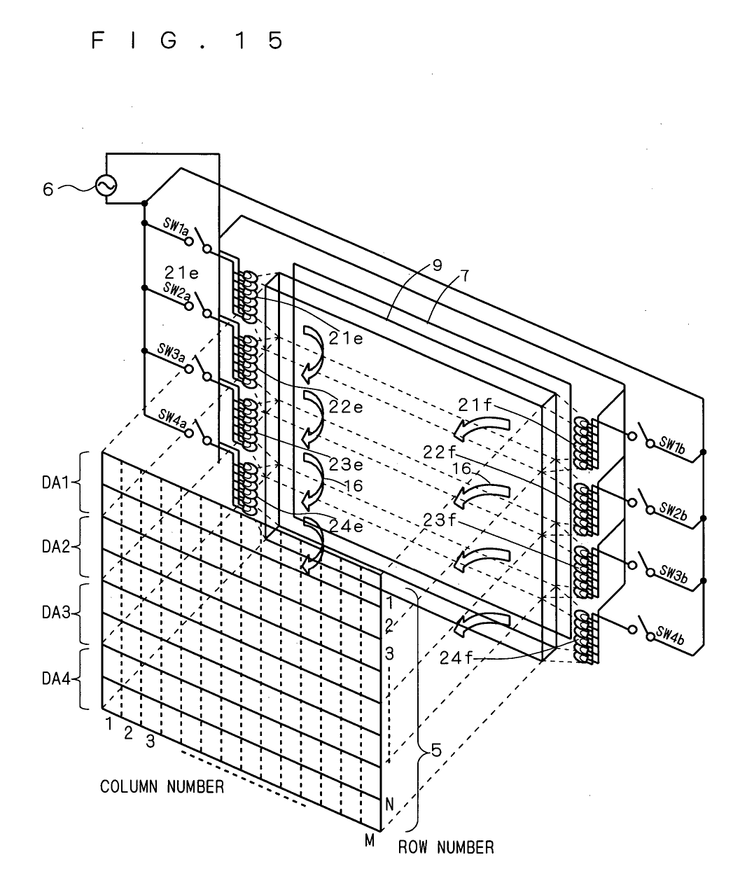

FIG. 15 is an explanatory diagram of backlight of liquid crystal display device in the sixth embodiment. As shown in the diagram, the transmission type liquid crystal panel 5 is composed of pixels of M columns×N rows same as in the first embodiment.

On the back side of the liquid crystal panel 5, a light guide plate 9 same as in the second embodiment is adhered, and a reflector plate 7 is adhered to its back side.

In the sixth embodiment, too, in the same manner as in the first embodiment, the liquid crystal panel 5 is divided into four divided regions DA1 to DA4, and corresponding to these divided regions DA1 to DA4, four spot emission light sources 21e to 24e and four spot emission light sources 21f to 24f of white LEDs and white LED groups are disposed vertically at both sides of light guide plate 9 (right and left sides; right and left sides of liquid crystal panel 5 in plan view as seen from the front of the liquid crystal panel 5). As a result, the backlight means composed of spot emission light sources 21e to 24e, spot emission light sources 21f to 24f, reflector plate 7, and light guide plate 9 is composed to diffuse and illuminate as uniformly as possible on the front side contacting with corresponding four divided regions DA1 to DA4 in the liquid crystal panel 5.

That is, the light emitted from the spot emission light sources 21e, 21f illuminates the divided region DA1, the light emitted from the spot emission light sources 22e, 22f illuminates the divided region DA2, the light emitted from the spot emission light sources 23e, 23f illuminates the divided region DA3, and the light emitted from the spot emission light sources 24e, 24f illuminates the divided region DA4.

Corresponding to the spot emission light sources 21e to 24e, one end each of switches SW1a to SW4a is connected, corresponding to the spot emission light sources 21f to 24f, one end each of switches SW1b to SW4b is connected, and other end of switches SW1a to SW4a and switches SW1b to SW4b is connected commonly to the backlight power source 6. That is, by turning on and off the switches SW1a to SW4a and switches SW1b to SW4b, the spot emission light sources 21e to 24e and spot emission light sources 21f to 24f are designed to light up and put out independently. The on/off control of switches SW1a to SW4a and switches SW1b to SW4b is operated by backlight driving circuits 11 to 14 not shown in FIG. 15.

In the sixth embodiment, the four divided regions DA1 to DA4 of the screen divided in vertical direction in the liquid crystal panel 5 are designed to light up and put out the backlight independently by spot emission light sources 21e to 24e and spot emission light sources 21f to 24f by turning on and off the switches SW1a to SW4a and switches SW1b to SW4b.

(Light Guide Plate)

The light guide plate 9 in the sixth embodiment is same as the light guide plate 9 in the second embodiment.

(Control Operation)

Control operation of liquid crystal display device in the sixth embodiment is same as the control operation in the first embodiment shown in FIG. 8. In the sixth embodiment, divided backlights 21 to 24 correspond to spot emission light sources 21e to 24e and spot emission light sources 21f to 24f.

(Backlight On/Off Control Unit)

The backlight on/off control unit in the sixth embodiment is realized by the same structure as in the first embodiment shown in FIG. 9 provided in the timing controller 2.

(Effects)

The liquid crystal display device of the sixth embodiment has the structure as mentioned above, and in the same manner as in the first embodiment, it is possible to obtain a time zone capable of achieving the target transmissivity in all pixels of divided region DA corresponding to lighting of the backlight which is lit and put out, even in the write response time Tw similar to conventional performance.

In addition, by dividing and disposing the spot emission light sources 21e to 24e vertically at the both sides of light guide plate 9, increase in thickness of liquid crystal module of transmission type can be avoided, and the device can be easily reduced in size same as in the first embodiment.

In the sixth embodiment, as compared with the fifth embodiment having spot emission light sources 21e to 24e disposed at one side of light guide plate, the same effects are advantageously obtained at double brightness.

As a result, it can be applied in thin type notebook personal computer, cellphone, and portable TV/DVD display device and the like, and it is effective to enhance the brightness. Depending on the case, it is expected to contribute to reduction of thickness of stationary type television broadcast display device and others.

Moreover, in the same manner as in the fourth embodiment, by using white LED or the like as spot emission light sources for backlight illumination, the operation life of emission light sources for lighting up and putting out can be extended. Further, response speed of lighting and extinguishing of emission light sources can be enhanced, and lighting can be controlled at smaller time intervals, and as compared with ray emission light sources, the element size can be reduced, and therefore the device can be manufactured in a further thin design while maintaining the brightness.

As a result, it can be applied in stationary type large-screen television broadcast display device and others in which luminance is very important, and further the operation life of the device can be extended.

### Seventh Embodiment

(Entire Configuration)

In the liquid crystal display device in a seventh embodiment, the entire configuration is same as in the first embodiment shown in FIG. 1 to FIG. 3.

(Structure of Backlight)

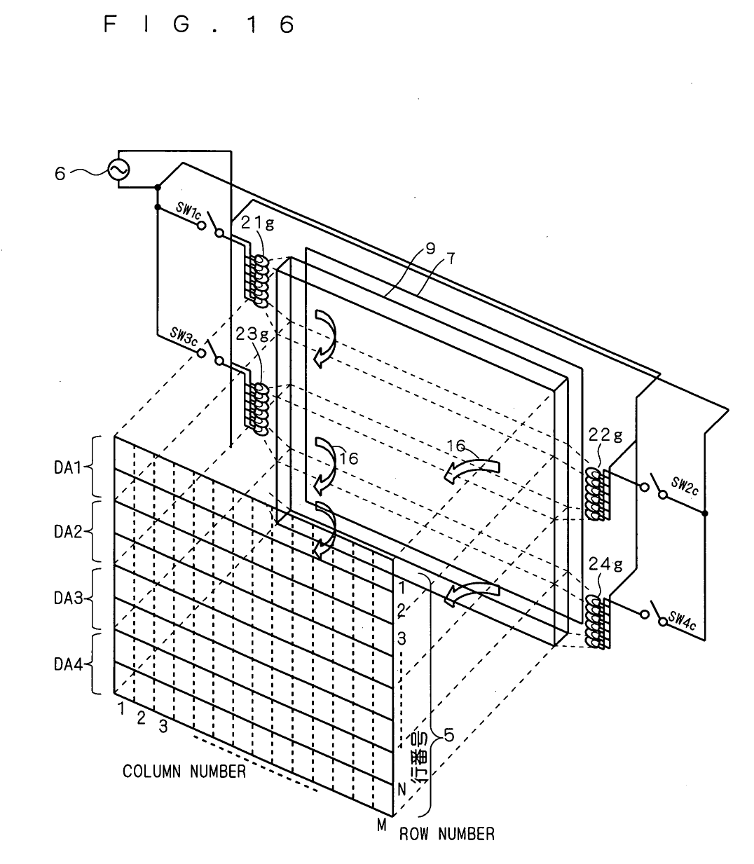

FIG. 16 is an explanatory diagram of backlight of liquid crystal display device in the seventh embodiment. As shown in the diagram, the transmission type liquid crystal panel 5 is composed of pixels of M columns×N rows same as in the first embodiment.

On the back side of the liquid crystal panel 5, a light guide plate 9 same as in the second embodiment is adhered, and a reflector plate 7 is adhered to its back side.

In the seventh embodiment, too, in the same manner as in the first embodiment, the liquid crystal panel 5 is divided into four divided regions DA1 to DA4, and corresponding to these divided regions DA1 to DA4, four spot emission light sources 21g to 24g of white LEDs are disposed vertically by two each side by side at both sides of light guide plate 9 (right and left sides; right and left sides of liquid crystal panel 5 in plan view as seen from the front of the liquid crystal panel 5). That is, in FIG. 16, the spot emission light source 21g and spot emission light source 23g are disposed at the left side, and the spot emission light source 22g and spot emission light source 24g are disposed at the right side.

As a result, the backlight means composed of spot emission light sources 21g to 24g, reflector plate 7, and light guide plate 9 is composed to diffuse and illuminate as uniformly as possible on the front side contacting with corresponding four divided regions DA1 to DA4 in the liquid crystal panel 5.

That is, the light emitted from the spot emission light source 21g illuminates the divided region DA1, the light emitted from the spot emission light source 22g illuminates the divided region DA2, the light emitted from the spot emission light source 23g illuminates the divided region DA3, and the light emitted from the spot emission light source 24g illuminates the divided region DA4.

Corresponding to the spot emission light sources 21g to 24g, one end each of switches SW1c to SW4c is connected, and other end of switches SW1c to SW4c is connected commonly to the backlight power source 6. That is, by turning on and off the switches SW1c to SW4c, the spot emission light sources 21g to 24g are designed to light up and put out independently. The on/off control of switches SW1c to SW4c is operated by backlight driving circuits 11 to 14 not shown in FIG. 16.

In the seventh embodiment, the four divided regions DA1 to DA4 of the screen divided in vertical direction in the liquid crystal panel 5 are designed to light up and put out the backlight independently by spot emission light sources 21g to 24g by turning on and off the switches SW1c to SW4c.

(Light Guide Plate)

The light guide plate 9 in the seventh embodiment is same as in the third embodiment.

(Control Operation)

Control operation of liquid crystal display device in the seventh embodiment is same as the control operation in the first embodiment shown in FIG. 8. In the seventh embodiment, divided backlights 21 to 24 correspond to spot emission light sources 21g to 24g.

(Backlight On/Off Control Unit)

The backlight on/off control unit in the seventh embodiment is realized by the same structure as in the first embodiment shown in FIG. 9 provided in the timing controller 2.

(Effects)

The liquid crystal display device of the seventh embodiment has the structure as mentioned above, and in the same manner as in the first embodiment, it is possible to obtain a time zone capable of achieving the target transmissivity in all pixels of divided region DA corresponding to lighting of the backlight which is lit and put out, even in the write response time Tw similar to conventional performance.

In addition, by dividing and disposing the spot emission light sources 21g to 24g vertically at the both sides of light guide plate 9, increase in thickness of liquid crystal module of transmission type can be avoided, and the device can be easily reduced in size same as in the first embodiment.

Further, by dispersed disposing spot emission light sources 21g and 23g out of four spot emission light sources 21g to 24g, at the left side of the light guide plate 9, and spot emission light sources 22g and 24g at the right side of the light guide plate 9 by two spot emission light sources, heat generation is not concentrated at one side, and as compared with the vertical layout of four spot emission light sources 21a to 24a, etc. as in the fifth embodiment and the sixth embodiment, physical space for disposing is assured, and seamless vertical light emission is realized.

As a result, it can be applied in thin type notebook personal computer, cellphone, and portable TV/DVD display device and the like, and it is also effective to make the housing design easier by scattering heat generation by illumination of spot emission light sources without concentrating at one side of light guide plate 9.

Moreover, in the same manner as in the fourth embodiment, by using white LED or the like as spot emission light sources for backlight illumination, the operation life of emission light sources for lighting up and putting out can be extended. Further, response speed of lighting and extinguishing of emission light sources can be enhanced, and lighting can be controlled at smaller time intervals, and as compared with ray emission light sources, the element size can be reduced, and therefore the device can be manufactured in a further thin design while maintaining the brightness.

As a result, it can be applied in stationary type large-screen television broadcast display device and others in which luminance is very important, and further the operation life of the device can be extended.

### Eighth Embodiment

(Entire Configuration)

In the liquid crystal display device in an eighth embodiment, the entire configuration is same as in the first embodiment shown in FIG. 1 to FIG. 3.

(Structure of Backlight)

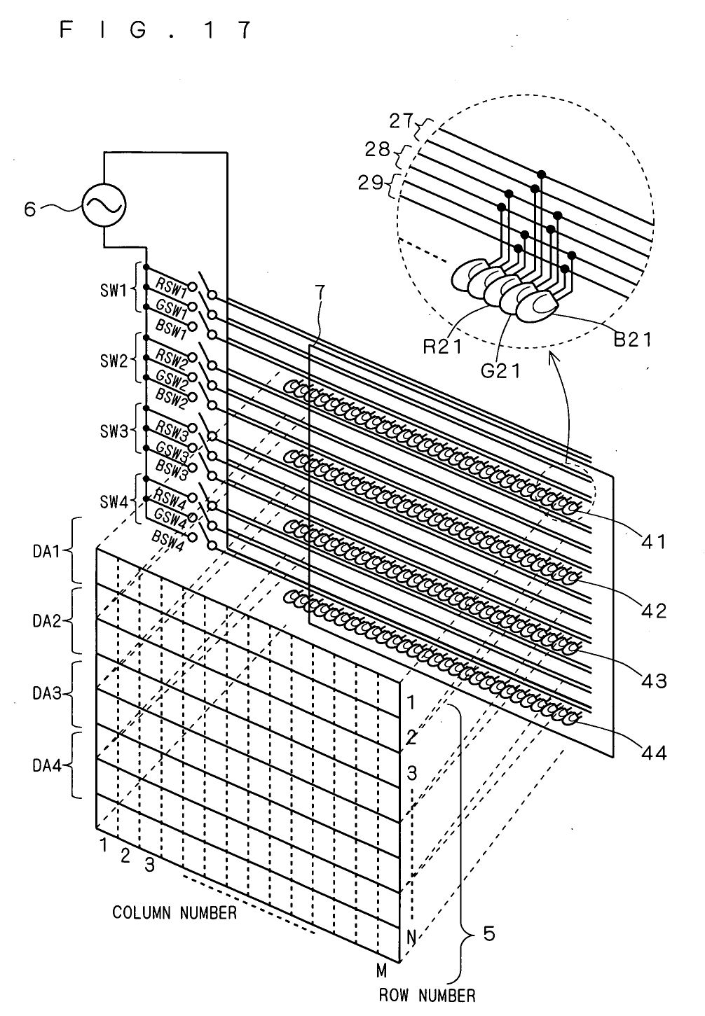

FIG. 17 is an explanatory diagram of backlight of liquid crystal display device in the eighth embodiment. As shown in the diagram, the transmission type liquid crystal panel 5 is composed of pixels of M columns×N rows same as in the first embodiment.

On the back side of the liquid crystal panel 5, four RGB spot emission light source groups 41 to 44 are disposed in the vertical direction of liquid crystal panel 5, and spot emission light sources 21d to 24d are extended and formed in the lateral direction. A reflector plate 7 is adhered to the back side of these spot emission light sources 21d to 24d.

The RGB spot emission light source groups 41 to 44 are composed of, as shown in magnified view, plural red spot emission light sources R21, green spot emission light sources G21, and blue spot emission light sources B21, and the red spot emission light sources R21 receive power supply from power supply wire for R 27, green spot emission light sources G21 receive power supply from power supply wire for G 28, and blue spot emission light sources B21 receive power supply from power supply wire for B 29.

In the eighth embodiment, too, in the same manner as in the first embodiment, the liquid crystal panel 5 is divided into four divided regions DA1 to DA4, and corresponding to these divided regions DA1 to DA4, RGB spot emission light source groups 41 to 44 are disposed. That is, in FIG. 17, the RGB spot emission light source groups 41 to 44 are disposed at the back side divided regions DA1 to DA4 of liquid crystal panel 5.

As a result, the backlight means composed of RGB spot emission light source groups 41 to 44 and reflector plate 7 is composed to diffuse and illuminate uniformly on the front side contacting with corresponding four divided regions DA1 to DA4 in the liquid crystal panel 5.

That is, the light emitted from the spot emission light source 41 illuminates the divided region DA1, the light emitted from the spot emission light source 42 illuminates the divided region DA2, the light emitted from the spot emission light source 43 illuminates the divided region DA3, and the light emitted from the spot emission light source 44 illuminates the divided region DA4.

In FIG. 17, RGB spot emission light source groups 41 to 44 are arranged in one row in lateral direction, having red spot emission light sources R21, green spot emission light sources G21, and blue spot emission light sources B21 disposed alternately, but they may be also divided in plural rows within same group corresponding to same divided region, or disposed in array. Anyway, the same effects are obtained as far as the four sets of RGB spot emission light source groups respectively illuminating the four divided regions DA1 to DA4 are disposed vertically same as the divided regions DA1 to DA4.

In the example shown in FIG. 17, the disposing ratio of spot emission light sources such as RGB LEDs is 1:1:1, but same effects are obtained if disposed at a ratio easy to achieve the target emission color (white) in relation to the light emission efficiency.

Corresponding to RGB spot emission light source groups 41 to 44, one end each of switches SW1 to SW4 is connected, and other end of switches SW1 to SW4 is connected commonly to the backlight power source 6. To be precise, switches SW1 to SW4 are respectively composed of switches for R RSW1 to RSW4, switches for G GSW1 to GSW4, and switches for B BSW1 to BSW4.

That is, by turning on and off the switches SW1 to SW4, the RGB spot emission light source groups 41 to 44 are designed to light up and put out independently. The on/off control of switches SW1 to SW4 is operated by backlight driving circuits 11 to 14 not shown in FIG. 17.

In the eighth embodiment, the four divided regions DA1 to DA4 of the screen divided in vertical direction in the liquid crystal panel 5 are designed to light up and put out the backlight independently by RGB spot emission light source groups 41 to 44 by turning on and off the switches SW1 to SW4.

(Control Operation)

Control operation of liquid crystal display device in the eighth embodiment is same as the control operation in the first embodiment shown in FIG. 8. In the eighth embodiment, divided backlights 21 to 24 correspond to RGB spot emission light source groups 41 to 44.

(Backlight On/Off Control Unit)

The backlight on/off control unit in the eighth embodiment is realized by the same structure as in the first embodiment shown in FIG. 9 provided in the timing controller 2.

(Effects)

The liquid crystal display device of the eighth embodiment has the structure as mentioned above, and in the same manner as in the first 5 embodiment, it is possible to obtain a time zone capable of achieving the target transmissivity in all pixels of divided region DA corresponding to lighting of the backlight which is lit and put out, even in the write response time Tw similar to conventional performance.

In addition, by dividing and disposing the RGB spot emission light source groups 41 to 44 vertically at the back side of liquid crystal panel 5, the same effects are obtained while holding a high luminance.

From the ray emission light sources such as fluorescent lamps used in the first embodiment to the third embodiment, by changing to spot emission light sources such as red spot emission light sources, the operation life of emission light sources for lighting up and putting out can be extended. Further, response speed of lighting and extinguishing of emission light sources can be enhanced, and lighting can be controlled at smaller time intervals, and as compared with ray emission light sources, the element size can be reduced, and therefore the device can be manufactured in a further thin design while maintaining the brightness.

As a result, it can be applied in stationary type large-screen television broadcast display device and others in which luminance is very important, and further the operation life of the device can be extended.

In the eighth embodiment, further, by using RGB spot emission light source groups consisting of independent spot emission light sources of three colors, mixing of colors RGB can be suppressed, and a hue of higher purity can be presented.

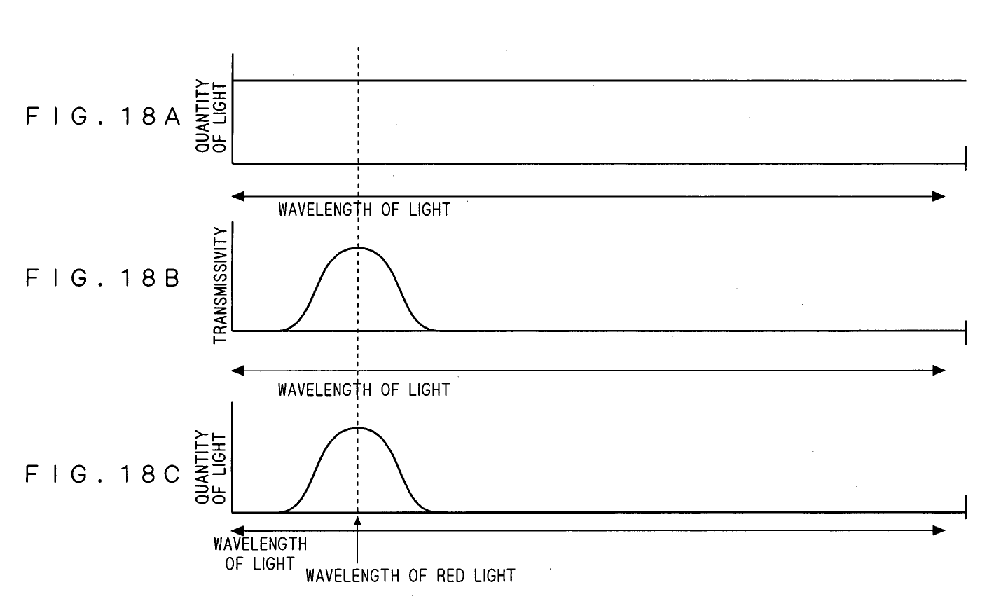

The effect of presenting a hue of higher purity is explained. FIGS. 18A-18C are graphs showing an example of red display in the case of backlight of ordinary white light.

When a white fluorescent lamp is used as backlight, the emission spectrum is distribution called white noise as shown in FIG. 18A, and the luminance is uniform in all frequency bands, and it hence looks like white. To extract red emission from this light, a filter transmitting only light in red region having transmissivity characteristic as shown in FIG. 18B is used. This filter has a characteristic of transmitting light of frequency having width in the center of frequency region of red emission light is used generally.

Therefore, the red light obtained by transmitting white light having the characteristic in FIG. 18A by the filter having the characteristic in FIG. 18B is light having a width in the axis of frequency about the center of red emission frequency as shown in FIG. 18C. Purity of color is degree of smallest of content of color of other frequency than the frequency of red light, and hence the red color obtained as backlight of ordinary white color is low in purity as compared with pure color.

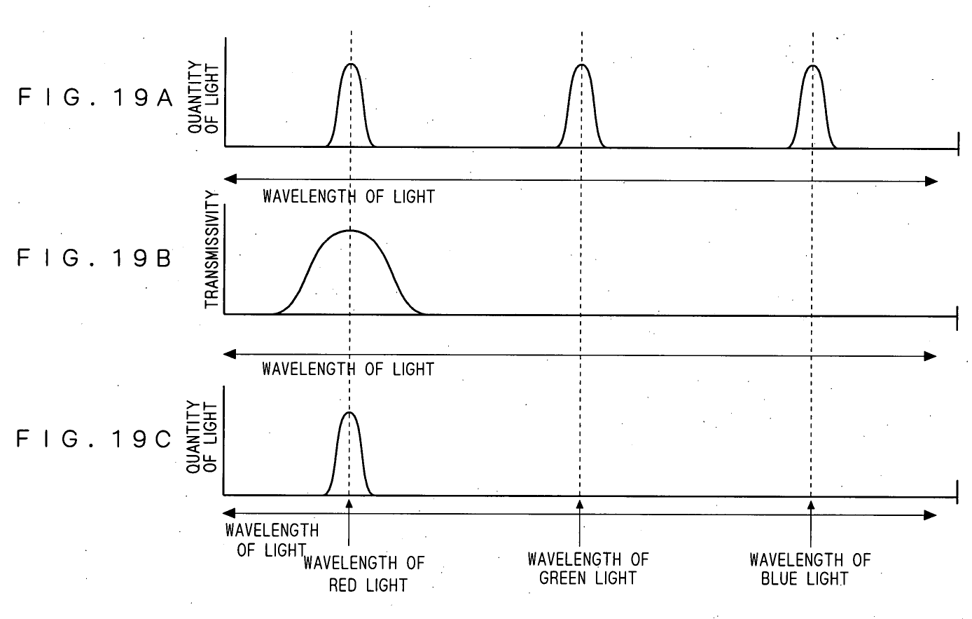

FIGS. 19A-19C are graphs showing an example of red display using the RGB emission light source group as backlight. As shown in FIG. 19A, it is generally known that the emission looks like white when red spot emission light sources R21, green spot emission light sources G21, and blue spot emission light sources B21 are illuminated at the same time.

Therefore, as a result of simultaneous emission of red spot emission light sources R21, green emission light sources G21, and blue spot emission light sources B21 consisting of light emitting lamps (LEDs etc.) of red, blue and green of high purity, white backlight is obtained.

Herein, in the same manner as in the example in FIGS. 18A-18C, when red light is extracted by using a red filter having transmission light spectrum characteristic as shown in FIG. 19B, as shown in FIG. 19C, the extracted red light is a red light of high purity same as the emission spectrum characteristic of red spot emission light source R21 such as original red LED.

In the eighth embodiment, by using the RGB spot emission light source group as backlight, a hue of high purity is obtained.

Further, by using switches capable of controlling independently in RGB colors (switch for red RSW1, switch for green GSW1, switch for blue BSW1, etc.), the lighting time of each color can be adjusted finely. Therefore, the color temperature (hue of white) can be adjusted. At the same time, by dividing the power source system by colors, the color temperature can be adjusted by controlling the supply voltage.

As a result, the liquid crystal display device of the eighth embodiment can be applied in stationary type large-screen television broadcast display device and others in which luminance is very important, and is further capable of controlling the hue and enhancing the operation life of the device. However, for individual control of RGB, it is required to control by further dividing the control operation shown in FIG. 8.

In this embodiment, switches are provided independently for RGB colors, but a common switch may be provided for three colors. In this case, although the color temperature cannot be adjusted, it is possible to have an intrinsic effect of presenting impulse emission by a simple structure.

### Ninth Embodiment

(Entire Configuration)

In the liquid crystal display device in a ninth embodiment, the entire configuration is same as in the first embodiment shown in FIG. 1 to FIG. 3.

(Structure of Backlight)

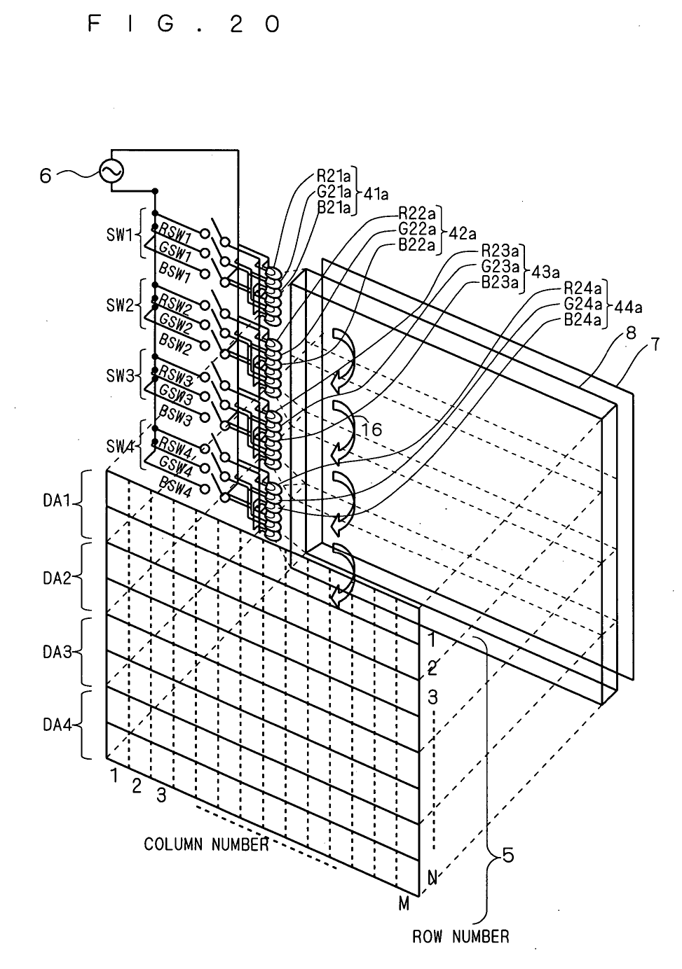

FIG. 20 is an explanatory diagram of backlight of liquid crystal display device in the ninth embodiment. As shown in the diagram, the transmission type liquid crystal panel 5 is composed of pixels of M columns×N rows same as in the first embodiment.

On the back side of the liquid crystal panel 5, a light guide plate 8 is adhered same as in the first embodiment, and a reflector plate 7 is adhered to its back side.

In the ninth embodiment, too, in the same manner as in the first embodiment, the liquid crystal panel 5 is divided into four divided regions DA1 to DA4, and corresponding to these divided regions DA1 to DA4, four RGB spot emission light source groups 41a to 44a are disposed vertically to the side of light guide plate 8 (left side; left side of liquid crystal panel 5 in plan view as seen from the front side of liquid crystal panel 5).

The RGB spot emission light source group 41a is composed of red spot emission light source R21a, green spot emission light source G21a, and blue spot emission light source B21a, the RGB spot emission light source group 42a is composed of red spot emission light source R22a, green spot emission light source G22a, and blue spot emission light source B22a, the RGB spot emission light source group 43a is composed of red spot emission light source R23a, green spot emission light source G23a, and blue spot emission light source B23a, and the RGB spot emission light source group 44a is composed of red spot emission light source R24a, green spot emission light source G24a, and blue spot emission light source B24a.

As a result, the backlight means composed of RGB spot emission light source groups 41a to 44a, reflector plate 7, and light guide plate 8 is composed to diffuse and illuminate as uniformly as possible on the front side contacting with corresponding four divided regions DA1 to DA4 in the liquid crystal panel 5.

That is, the light emitted from the RGB spot emission light source 41a illuminates the divided region DA1, the light emitted from the RGB spot emission light source 42a illuminates the divided region DA2, the light emitted from the RGB spot emission light source 43a illuminates the divided region DA3, and the light emitted from the RGB spot emission light source 44a illuminates the divided region DA4.

Corresponding to RGB spot emission light source groups 41a to 44a, one end each of switches SW1 to SW4 is connected, and other end of switches SW1 to SW4 is connected commonly to the backlight power source 6. To be precise, switches SW1 to SW4 are respectively composed of switches for R RSW1 to RSW4, switches for G GSW1 to GSW4, and switches for B BSW1 to BSW4. These switches can be controlled independently.

Therefore, by turning on and off the switches SW1 to SW4, the RGB spot emission light source groups 41a to 44a are designed to light up and put out independently. The on/off control of switches SW1 to SW4 is operated by backlight driving circuits 11 to 14 not shown in FIG. 20.

In the ninth embodiment, the four divided regions DA1 to DA4 of the screen divided in vertical direction in the liquid crystal panel 5 are designed to light up and put out the backlight independently by RGB spot emission light source groups 41a to 44a by turning on and off the switches SW1 to SW4.

(Light Guide Plate)

The light guide plate 8 in the ninth embodiment is same as the light guide plate 8 in the first embodiment.

(Control Operation)

Control operation of liquid crystal display device in the ninth embodiment is same as the control operation in the first embodiment shown in FIG. 8. In the ninth embodiment, divided backlights 21 to 24 correspond to RGB spot emission light source groups 41a to 44a.

(Backlight On/Off Control Unit)

The backlight on/off control unit in the ninth embodiment is realized by the same structure as in the first embodiment shown in FIG. 9 provided in the timing controller 2.

(Effects)

The liquid crystal display device of the ninth embodiment has the structure as mentioned above, and in the same manner as in the first embodiment, it is possible to obtain a time zone capable of achieving the target transmissivity in all pixels of divided region DA corresponding to lighting of the backlight which is lit and put out, even in the write response time Tw similar to conventional performance.

In addition, by dividing and disposing the RGB spot emission light source groups 41a to 44a vertically at the lateral side of light guide plate 8, increase in thickness of liquid crystal module of transmission type can be avoided, and the device can be easily reduced in size same as in the first embodiment.

Moreover, in the same manner as in the fourth embodiment, by using spot emission light sources such as red spot emission light sources, green spot emission light sources, and blue spot emission light sources, for backlight illumination, the operation life of emission light sources for lighting up and putting out can be extended. Further, response speed of lighting and extinguishing of emission light sources can be enhanced, and lighting can be controlled at smaller time intervals, and as compared with ray emission light sources, the element size can be reduced, and therefore the device can be manufactured in a further thin design while maintaining the brightness.

As a result, it can be applied in stationary type large-screen television broadcast display device and others in which luminance is very important, and further the operation life of the device can be extended.

In the ninth embodiment, in the same manner as in the eighth embodiment, by using the RGB spot emission light source group of independent three colors, blending of three colors of RGB can be suppressed, and a hue of high purity is obtained.

Further, in the same manner as in the eighth embodiment, by using switches capable of controlling independently in RGB colors, the lighting time of each color can be adjusted finely, and the color temperature can be adjusted. At the same time, by dividing the power source system by colors, the color temperature can be adjusted by controlling the supply voltage.

As a result, the liquid crystal display device of the ninth embodiment can be applied in stationary type large-screen television broadcast display device and others in which luminance is very important, and is further capable of controlling the hue and enhancing the operation life of the device. However, for individual control of RGB, it is required to control by further dividing the control operation shown in FIG. 8.

Thus, the liquid crystal display device of the ninth embodiment can be applied in thin type notebook personal computer, cellphone, and portable TV/DVD) display device, and further contributes to reduction of size and weight and extension of service life of these devices, and is also capable of adjusting the hue (color temperature), and hence brings about abundant functions to the end user.

In this embodiment, switches are provided independently for RGB colors, but a common switch may be provided for three colors. In this case, although the color temperature cannot be adjusted, it is possible to have an intrinsic effect of presenting impulse emission by a simple structure.

### Tenth Embodiment

(Entire Configuration)

In the liquid crystal display device in a tenth embodiment, the entire configuration is same as in the first embodiment shown in FIG. 1 to FIG. 3.

(Structure of Backlight)

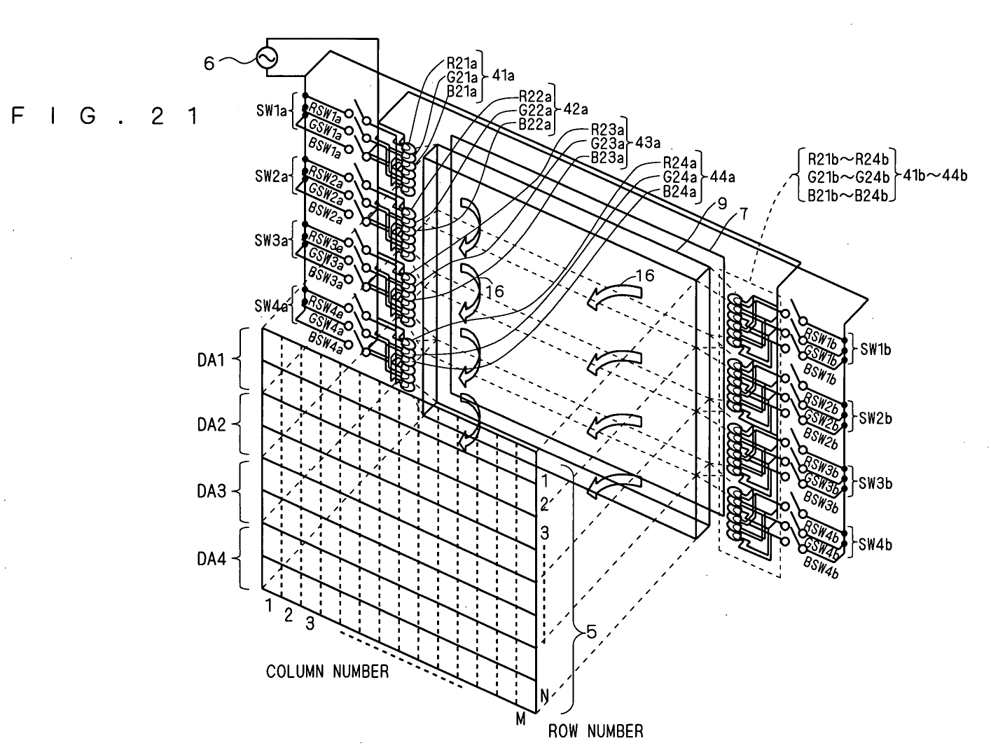

FIG. 21 is an explanatory diagram of backlight of liquid crystal display device in the tenth embodiment. As shown in the diagram, the transmission type liquid crystal panel 5 is composed of pixels of M columns×N rows same as in the first embodiment.

On the back side of the liquid crystal panel 5, a light guide plate 9 is adhered same as in the second embodiment, and a reflector plate 7 is adhered to its back side.

In the tenth embodiment, too, in the same manner as in the first embodiment, the liquid crystal panel 5 is divided into four divided regions DA1 to DA4, and corresponding to these divided regions DA1 to DA4, four RGB spot emission light source groups 41a to 44a and RGB spot emission light source groups 41b to 44b are disposed vertically to both sides of light guide plate 9 (right and left sides; right and left sides of liquid crystal panel 5 in plan view as seen from the front side of liquid crystal panel 5).

The RGB spot emission light source group 41a is composed of red spot emission light source R21a, green spot emission light source G21a, and blue spot emission light source B21a, the RGB spot emission light source group 42a is composed of red spot emission light source R22a, green spot emission light source G22a, and blue spot emission light source B22a, the RGB spot emission light source group 43a is composed of red spot emission light source R23a, green spot emission light source G23a, and blue spot emission light source B23a, and the RGB spot emission light source group 44a is composed of red spot emission light source R24a, green spot emission light source G24a, and blue spot emission light source B24a.

The RGB spot emission light source group 41b is composed of red spot emission light source R21b, green spot emission light source G21b, and blue spot emission light source B21b, the RGB spot emission light source group 42b is composed of red spot emission light source R22b, green spot emission light source G22b, and blue spot emission light source B22b, the RGB spot emission light source group 43b is composed of red spot emission light source R23b, green spot emission light source G23b, and blue spot emission light source B23b, and the RGB spot emission light source group 44b is composed of red spot emission light source R24b, green spot emission light source G24b, and blue spot emission light source B24b.

As a result, the backlight means composed of RGB spot emission light source groups 41a to 44a, RGB spot emission light source groups 41b to 44b, reflector plate 7, and light guide plate 9 is composed to diffuse and illuminate as uniformly as possible on the front side contacting with corresponding four divided regions DA1 to DA4 in the liquid crystal panel 5.

That is, the light emitted from the RGB spot emission light source groups 41a, 41b illuminates the divided region DA1, the light emitted from the RGB spot emission light source groups 42a, 42b illuminates the divided region DA2, the light emitted from the RGB spot emission light source groups 43a, 43b illuminates the divided region DA3, and the light emitted from the RGB spot emission light source groups 44a, 44b illuminates the divided region DA4.

Corresponding to RGB spot emission light source groups 41a to 44a, one end each of switches SW1a to SW4a is connected, corresponding to RGB spot emission light source groups 41b to 44b, one end each of switches SW1b to SW4b is connected, and other end of switches SW1a to SW4a and switches SW1b to SW4b is connected commonly to the backlight power source 6.

The switches SW1a to SW4a are respectively composed of switches for R RSW1a to RSW4a, switches for G GSW1a to GSW4a, and switches for B BSW1a to BSW4a, and the switches SW1b to SW4b are respectively composed of switches for R RSW1b to RSW4b, switches for G GSW1b to GSW4b, and switches for B BSW1b to BSW4b. These switches can be controlled independently.

Therefore, by turning on and off the switches SW1a to SW4a and switches SW1b to SW4b, the RGB spot emission light source groups 41a to 44a and RGB spot emission light source groups 41b to 44b are designed to light up and put out independently. The on/off control of switches SW1a to SW4a and switches SW1b to SW4b is operated by backlight driving circuits 11 to 14 not shown in FIG. 21.

In the tenth embodiment, the four divided regions DA1 to DA4 of the screen divided in vertical direction in the liquid crystal panel 5 are designed to light up and put out the backlight independently by RGB spot emission light source groups 41a to 44a and RGB spot emission light source groups 41b to 44b by turning on and off the switches SW1a to SW4a and switches SW1b to SW4b.

(Light Guide Plate)

The light guide plate 9 in the tenth embodiment is same as the light guide plate 9 in the second embodiment.

(Control Operation)

Control operation of liquid crystal display device in the tenth embodiment is same as the control operation in the first embodiment shown in FIG. 8. In the tenth embodiment, divided backlights 21 to 24 correspond to RGB spot emission light source groups 41a to 44a and RGB spot emission light source groups 41b to 44b.

(Backlight On/Off Control Unit)

The backlight on/off control unit in the tenth embodiment is realized by the same structure as in the first embodiment shown in FIG. 9 provided in the timing controller 2.

(Effects)

The liquid crystal display device of the tenth embodiment has the structure as mentioned above, and in the same manner as in the first embodiment, it is possible to obtain a time zone capable of achieving the target transmissivity in all pixels of divided region DA corresponding to lighting of the backlight which is lit and put out, even in the write response time Tw similar to conventional performance.

In addition, by dividing and disposing the RGB spot emission light source groups 41a to 44a and RGB spot emission light source groups 41b to 44b vertically at the both sides, increase in thickness of liquid crystal module of transmission type can be avoided, and the device can be easily reduced in size same as in the first embodiment.

Moreover, in the tenth embodiment, by using RGB spot emission light source groups as backlight illumination, the operation life of emission light sources for lighting up and putting out can be extended. Further, response speed of lighting and extinguishing of emission light sources can be enhanced, and lighting can be controlled at smaller time intervals, and as compared with ray emission light sources, the element size can be reduced, and therefore the device can be manufactured in a further thin design while maintaining the brightness.

As a result, it can be applied in stationary type large-screen television broadcast display device and others in which luminance is very important, and further the operation life of the device can be extended.

In the tenth embodiment, as compared with the RGB spot emission light source groups 41a to 44a disposed at one side in the ninth embodiment, the same effects are obtained at double brightness.

As a result, it can be applied in thin type notebook personal computer, cellphone, and portable TV/DVD display device, and its brightness can be enhanced at the same time. Depending on the case, it also seems to contribute to reduction of thickness of stationary TV broadcast display device.

Further in the tenth embodiment, in the same manner as in the eighth embodiment, by using RGB spot emission light source groups consisting of spot emission light sources of three independent colors, blending of three colors of RGB can be suppressed, and a hue of high purity is obtained.

Further, in the same manner as in the eighth embodiment, by using switches capable of controlling independently in RGB colors, the lighting time of each color can be adjusted finely, and the color temperature can be adjusted. At the same time, by dividing the power source system by colors, the color temperature can be adjusted by controlling the supply voltage.

As a result, the liquid crystal display device of the tenth embodiment can be applied in stationary type large-screen television broadcast display device and others in which luminance is very important, and is further capable of controlling the hue and enhancing the operation life of the device. However, for individual control of RGB, it is required to control by further dividing the control operation shown in FIG. 8.

Thus, the liquid crystal display device of the tenth embodiment can be applied in thin type notebook personal computer, cellphone, and portable TV/DVD display device, and further contributes to reduction of size and weight and extension of service life of these devices, and is also capable of adjusting the hue (color temperature), and hence brings about abundant functions to the end user.

In this embodiment, switches are provided independently for RGB colors, but a common switch may be provided for three colors. In this case, although the color temperature cannot be adjusted, it is possible to have an intrinsic effect of presenting impulse emission by a simple structure.

### Eleventh Embodiment

(Entire Configuration)

In the liquid crystal display device in an eleventh embodiment, the entire configuration is same as in the first embodiment shown in FIG. 1 to FIG. 3.

(Structure of Backlight)

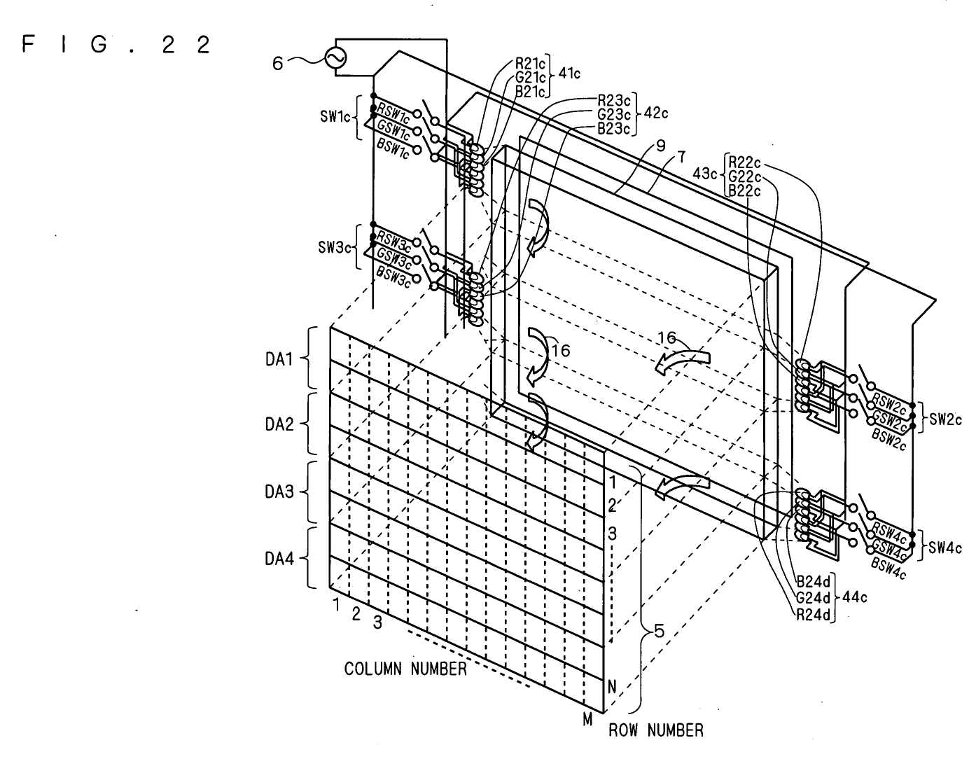

FIG. 22 is an explanatory diagram of backlight of liquid crystal display device in the eleventh embodiment. As shown in the diagram, the transmission type liquid crystal panel 5 is composed of pixels of M columns×N rows same as in the first embodiment.

On the back side of the liquid crystal panel 5, a light guide plate 9 is adhered same as in the second embodiment, and a reflector plate 7 is adhered to its back side.

In the eleventh embodiment, too, in the same manner as in the first embodiment, the liquid crystal panel 5 is divided into four divided regions DA1 to DA4, and corresponding to these divided regions DA1 to DA4, RGB spot emission light source groups 41c to 44c are disposed vertically by two each at both sides of light guide plate 9 (right and left sides; right and left sides of liquid crystal panel 5 in plan view as seen from the front side of liquid crystal panel 5). That is, in FIG. 22, RGB spot emission light source group 41c, and RGB spot emission light source group 43c are disposed at the left side, and RGB spot emission light source group 42c and RGB spot emission light source group 44c are disposed at the right side.

The RGB spot emission light source group 41c is composed of red RGB spot emission light source R21c, green RGB spot emission light source G21c, and blue RGB spot emission light source B21c, the RGB spot emission light source group 42c is composed of red RGB spot emission light source R22c, green RGB spot emission light source G22c, and blue RGB spot emission light source B22c, the RGB spot emission light source group 43c is composed of red RGB spot emission light source R23c, green RGB spot emission light source G23c, and blue RGB spot emission light source B23c, and the RGB spot emission light source group 44c is composed of red RGB spot emission light source R24c, green RGB spot emission light source G24c, and blue RGB spot emission light source B24c.

As a result, the backlight means composed of RGB spot emission light source groups 41c to 44c, reflector plate 7, and light guide plate 9 is composed to diffuse and illuminate as uniformly as possible on the front side contacting with corresponding four divided regions DA1 to DA4 in the liquid crystal panel 5.

That is, the light emitted from the RGB spot emission light source group 41c illuminates the divided region DA1, the light emitted from the RGB spot emission light source group 42c illuminates the divided region DA2, the light emitted from the RGB spot emission light source group 43c illuminates the divided region DA3, and the light emitted from the RGB spot emission light source group 44c illuminates the divided region DA4.

Corresponding to RGB spot emission light source groups 41c to 44c, one end each of switches SW1c to SW4c is connected, and other end of switches SW1c to SW4c is connected commonly to the backlight power source 6. The switches SW1c to SW4c are respectively composed of switches for R RSW1c to RSW4c, switches for G GSW1c to GSW4c, and switches for B BSW1c to BSW4c. These switches can be controlled independently.

Therefore, by turning on and off the switches SW1c to SW4c, the RGB spot emission light source groups 41c to 44c are designed to light up and put out independently. The on/off control of switches SW1c to SW4c is operated by backlight driving circuits 11 to 14 not shown in FIG. 22.

In the eleventh embodiment, the four divided regions DA1 to DA4 of the screen divided in vertical direction in the liquid crystal panel 5 are designed to light up and put out the backlight independently by RGB spot emission light source groups 41c to 44c by turning on and off the switches SW1c to SW4c.

(Light Guide Plate)

The light guide plate 9 in the eleventh embodiment is composed same as in the third embodiment.

(Control Operation)

Control operation of liquid crystal display device in the eleventh embodiment is same as the control operation in the first embodiment shown in FIG. 8. In the eleventh embodiment, divided backlights 21 to 24 correspond to RGB spot emission light source groups 41c to 44c.

(Backlight On/Off Control Unit)

The backlight on/off control unit in the eleventh embodiment is realized by the same structure as in the first embodiment shown in FIG. 9 provided in the timing controller 2.

(Effects)

The liquid crystal display device of the eleventh embodiment has the structure as mentioned above, and in the same manner as in the first embodiment, it is possible to obtain a time zone capable of achieving the target transmissivity in all pixels of divided region DA corresponding to lighting of the backlight which is lit and put out, even in the write response time Tw similar to conventional performance.

In addition, by dividing and disposing the RGB spot emission light source groups 41c to 44c vertically at one side, increase in thickness of liquid crystal module of transmission type can be avoided, and the device can be easily reduced in size same as in the first embodiment.

Moreover, of the four RGB spot emission light source groups 41c to 44c, by dispersed disposing RGB spot emission light source groups 41c, 43c at the left side, and RGB spot emission light source groups 42c, 44c at the right side, heat generation is not concentrated at one side by two spot emission light source groups, and as compared with the vertical layout of four ray emission light sources 21a to 24a, etc. as in the ninth embodiment and the tenth embodiment, physical space for disposing is assured, and seamless vertical light emission is realized.

As a result, it can be applied in thin type notebook personal computer, cellphone, and portable TV/DVD display device and the like, and it is also effective to make the housing design easier by scattering heat generation by illumination of RGB spot emission light sources without concentrating at one side.

In the eleventh embodiment, too, by using RGB spot emission light source groups as backlight illumination, the operation life of emission light sources for lighting up and putting out can be extended. Further, response speed of lighting and extinguishing of emission light sources can be enhanced, and lighting can be controlled at smaller time intervals, and as compared with ray emission light sources, the element size can be reduced, and therefore the device can be manufactured in a further thin design while maintaining the brightness.

As a result, it can be applied in stationary type large-screen television broadcast display device and others in which luminance is very important, and further the operation life of the device can be extended.

In the eleventh embodiment, in the same manner as in the eighth embodiment, by using RGB spot emission light source groups consisting of spot emission light sources of three independent colors, blending of three colors of RGB can be suppressed, and a hue of high purity is obtained.

Further, in the same manner as in the eighth embodiment, by using switches capable of controlling independently in RGB colors, the lighting time of each color can be adjusted finely, and the color temperature can be adjusted. At the same time, by dividing the power source system by colors, the color temperature can be adjusted by controlling the supply voltage.

As a result, the liquid crystal display device of the eleventh embodiment can be applied in stationary type large-screen television broadcast display device and others in which luminance is very important, and is further capable of controlling the hue and enhancing the operation life of the device. However, for individual control of RGB, it is required to control by further dividing the control operation shown in FIG. 8.

Thus, the liquid crystal display device of the eleventh embodiment can be applied in thin type notebook personal computer, cellphone, and portable TV/DVD display device, and further contributes to reduction of size and weight and extension of service life of these devices, and is also capable of adjusting the hue (color temperature), and hence brings about abundant functions to the end user.

In this embodiment, switches are provided independently for RGB colors, but a common switch may be provided for three colors. In this case, although the color temperature cannot be adjusted, it is possible to have an intrinsic effect of presenting impulse emission by a simple structure.

### Twelfth Embodiment

(Entire Configuration)

In the liquid crystal display device in a twelfth embodiment, the entire configuration is same as in the first embodiment shown in FIG. 1 to FIG. 3.

(Structure of Backlight)

The structure of backlight in the twelfth embodiment is same as the structure of backlight shown in any one of the first to eleventh embodiments.

(Light Guide Plate)

The light guide plate in the twelfth embodiment is same as the light guide plate (light guide plate 8 or light guide plate 9) conforming to the structure of backlight shown in any one of the first to eleventh embodiments.

(Control Operation)

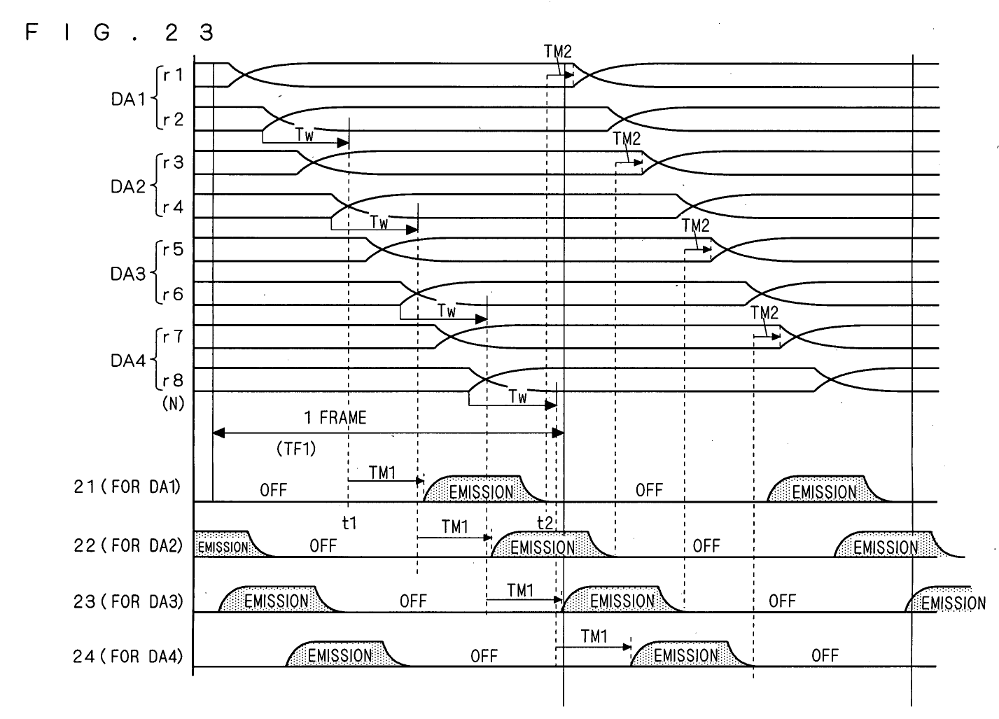

FIG. 23 is a timing chart showing the timing relation of data writing and backlight lighting and extinguishing in divided regions DA1 to DA4 in the embodiment. In the diagram, for the sake of explanation, divided regions DA1 to DA4 are displayed by two rows each in a total of N=8.

Control operation in the first to eleventh embodiments is shown in FIG. 8, but in this embodiment, by shortening the lighting time of divided backlights 21 to 24, it is settled within the time of achieving the target transmissivity of all pixels in the corresponding divided regions DA1 to DA4.

For example, in display of divided region DA1, the divided backlight 21 is lit after margin TM1 (≧0) from time t1 after lapse of response time Tw from start of writing of final row r2, and the divided backlight 21 is put out (off) before margin TM2 (≧0) from rewriting start time t2 of first row r1, and therefore the divided backlight 21 is being lit only within the time of achieving the target transmissivity of all pixels in the divided region DA1.

Similarly, lighting (emission) and extinguishing (off) of divided backlights 22 to 24 of divided regions DA2 to DA4 are controlled. The lighting time of divided backlights 21 to 24 is supposed to be approximately ¼ frame (4 ms) or less.

(Backlight On/Off Control Unit)

The backlight on/off control unit in the twelfth embodiment is realized by the same structure as in the first embodiment shown in FIG. 9 provided in the timing controller 2. However, in order to control lighting (emission) and extinguishing (off) of divided backlights 21 to 24 at the timing shown in FIG. 23, the number of stages of D flip-flops EFF1 to EFFk, and the number of D flip-flops LFF must be adjusted.

(Effects)

Original effects of liquid crystal display device of the twelfth embodiment are described below. In the twelfth embodiment, as mentioned above, by shortening the lighting time of divided backlights 21 to 24, and finishing lighting (illumination) within the time of achieving the target transmissivity of all pixels in the corresponding divided regions DA1 to DA4, the same moving image display performance as in the existing cathode-ray tube display device is realized by the liquid crystal module and writing procedure in the write response time Tw same as in the conventional performance.

Further, by shortening the lighting time and achieving the target transmissivity in all pixels while lighting, the efficiency of use of backlight can be further enhanced, and the peak luminance is enhanced at same power consumption, and greater peak power can be used, and decrease of luminance can be decreased at same power consumption.

Thus, the liquid crystal display device of the twelfth embodiment can achieve a favorable moving image display performance in all apparatuses mounting transmission type liquid crystal display device for displaying moving images.

### Thirteenth Embodiment

(Entire Configuration)

In the liquid crystal display device in a thirteenth embodiment, the entire configuration is same as in the first embodiment shown in FIG. 1 to FIG. 3.

(Structure of Backlight)

The structure of backlight in the thirteenth embodiment is same as the structure of backlight shown in any one of the first to eleventh embodiments.

(Light Guide Plate)

The light guide plate in the thirteenth embodiment is same as the light guide plate (light guide plate 8 or light guide plate 9) conforming to the structure of backlight shown in any one of the first to eleventh embodiments.

(Control Operation)

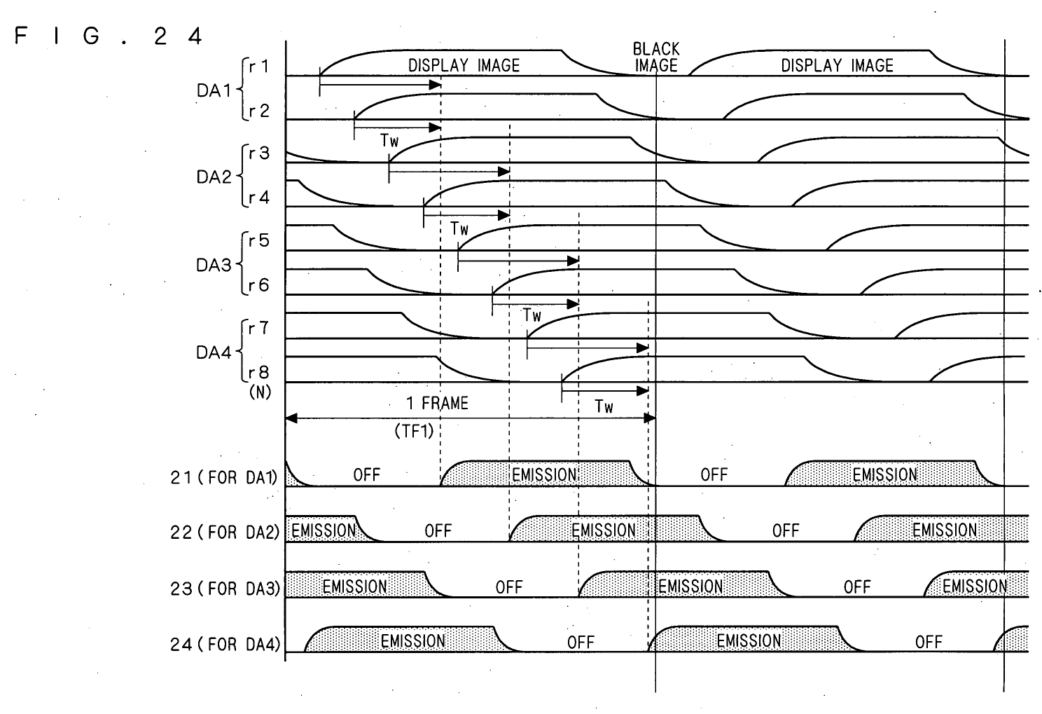

FIG. 24 is a timing chart showing the timing relation of data writing and backlight lighting and extinguishing in divided regions DA1 to DA4 in the embodiment. In the diagram, for the sake of explanation, divided regions DA1 to DA4 are displayed by two rows each in a total of N=8.

Control operation in the first to eleventh embodiments is shown in FIG. 8, but in the thirteenth embodiment, lighting of divided backlights 21 to 24 is controlled by combination with insertion of black screen.

In the thirteenth embodiment, one frame period TF1 is divided into two sections, and image writing operation is executed so that ordinary display image is shown in one period, while black image is displayed in other period.

In insertion of black screen, in one ordinary frame period TF1, one pixel is written two times, that is, ordinary pixel (ordinary image data) and black pixel (black image data), and it is equivalent to writing of fields 120 times in one second. It is hence required that the writing speed by source driver 3 and gate driver 4 should be increased by about two times of the first embodiment.

The dividing ratio of display image and black image in one frame period TF1 is not required to be 1:1, but it is determined in relation to the number of divisions of region of liquid crystal panel 5 (4 in the example in FIG. 24) and increase of operation speed by insertion of black screen.

For example, the operation speed is improved to write response time Tw of 4 ms (about ¼ frame period), and when the screen is composed of four divisions, about 3:1 is assumed.

In this case, data writing start deviation of first and final rows in four divided regions DA1 to DA4 is about ¼ period, and write response time Tw is ¼ as mentioned above, each image display period of divided regions DA1 to DA4 is a total of ¾ frame (dividing ratio of 3:1 as mentioned above), and hence in ¼ frame period (=¾-¼-¼), all pixels settle at target transmissivity in divided regions DA1 to DA4.

In divided regions DA1 to DA4, the divided backlights 21 to 24 are controlled to light up divided backlights 21 to 24 in the period of all pixels settling at target transmissivity, and image display of impulse response type is realized.

(Backlight On/Off Control Unit)

The backlight on/off control unit in the thirteenth embodiment is realized by the same structure as in the first embodiment shown in FIG. 9 provided in the timing controller 2. However, in order to control lighting and extinguishing of divided backlights 21 to 24 at the timing shown in FIG. 24, the number of stages of D flip-flops EFF1 to EFFk, and the number of D flip-flops LFF must be adjusted.

(Effects)

Original effects of liquid crystal display device of the thirteenth embodiment are described below. In the thirteenth embodiment, as mentioned above, by combining black screen insertion and backlight lighting and extinguishing, the response performance is enhanced without using expensive frame memory, and image display of impulse response type is realized at same power consumption without losing brightness by the liquid crystal module in the write response time same as in the conventional performance.

As a result, it can achieve a favorable moving image display performance in all apparatuses mounting transmission type liquid crystal display device for displaying moving images.

### Fourteenth Embodiment

(Entire Configuration)

In the liquid crystal display device in a fourteenth embodiment, the entire configuration is same as in the first embodiment shown in FIG. 1 to FIG. 3.

(Structure of Backlight)

The structure of backlight in the fourteenth embodiment is same as the structure of backlight shown in any one of the first to eleventh embodiments.

(Light Guide Plate)

The light guide plate in the fourteenth embodiment is same as the light guide plate (light guide plate 8 or light guide plate 9) conforming to the structure of backlight shown in any one of the first to eleventh embodiments.

(Control Operation)

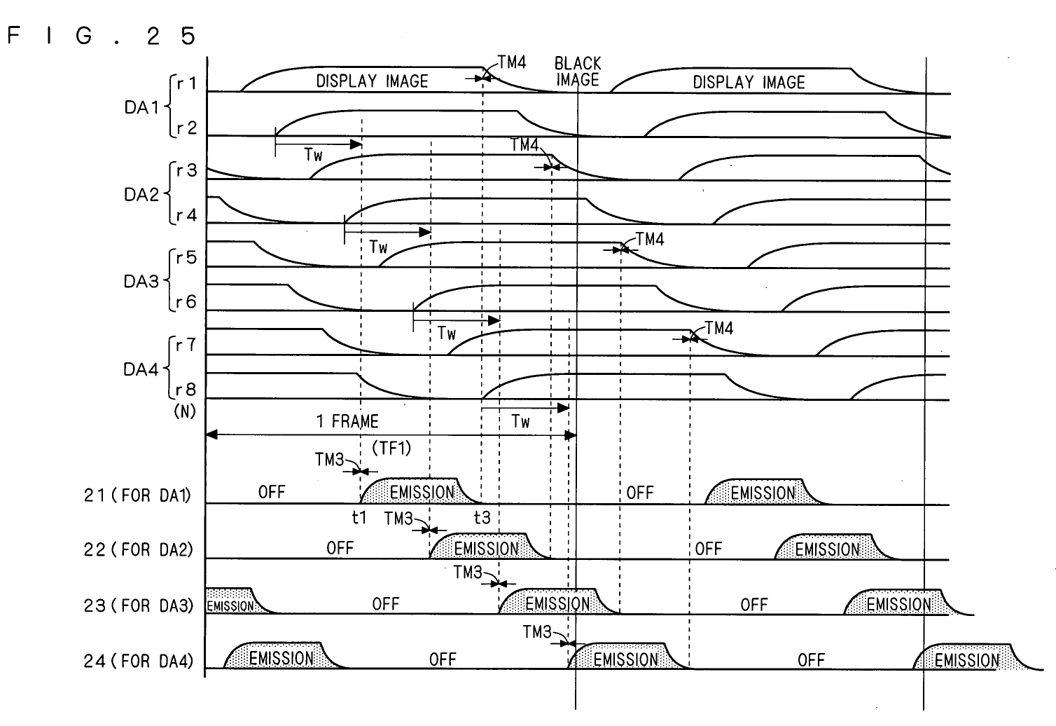

FIG. 25 is a timing chart showing the timing relation of data writing and backlight lighting and extinguishing in divided regions DA1 to DA4 in the embodiment. In the diagram, for the sake of explanation, divided regions DA1 to DA4 are displayed by two rows each in a total of N=8.

Control operation in the first to eleventh embodiments is shown in FIG. 8, but in this embodiment, in the same manner as in the twelfth embodiment, by shortening the lighting time of divided backlights 21 to 24, it is settled within the time of achieving the target transmissivity of all pixels in the corresponding divided regions DA1 to DA4.

Further, in the same manner as in the thirteenth embodiment, one frame period TF1 is divided into two sections, and image writing operation is executed so that ordinary display image is shown in one period, while black image is displayed in other period.

For example, in display of divided region DA1, the divided backlight 21 is lit after margin TM3 (≧0) from time t1 after lapse of response time Tw from start of writing of final row r2, and the divided backlight 21 is put out (off) before margin TM4 (≧0) from rewriting start time t3 in black image of first row r1, and therefore the divided backlight 21 is being lit only within the time of achieving the target transmissivity of all pixels in the divided region DA1. In FIG. 25, margins TM3 and TM4 are both 0.

Similarly, lighting and extinguishing of divided backlights 22 to 24 of divided regions DA2 to DA4 are controlled. The lighting time of divided backlights 21 to 24 is supposed to be approximately ¼ frame (4 ms) or less.

On the other hand, dividing ratio of display image and black image in one frame period TF1 is, in the same manner as in the thirteenth embodiment, determined in relation to the number of divisions of region of liquid crystal panel 5 and increase of operation speed by insertion of black screen, for example, it is supposed to be about 3:1.

In this case, in the same manner as in the third embodiment, in ¼ frame period, all pixels are settling at target transmissivity in divided regions DA1 to DA4.

In divided regions DA1 to DA4, the divided backlights 21 to 24 are controlled to light up divided backlights 21 to 24 in the period of all pixels settling at target transmissivity, and image display of impulse response type is realized.

(Backlight On/Off Control Unit)

The backlight on/off control unit in the fourteenth embodiment is realized by the same structure as in the first embodiment shown in FIG. 9 provided in the timing controller 2. However, in order to control lighting and extinguishing of divided backlights 21 to 24 at the timing shown in FIG. 25, the number of stages of D flip-flops EFF1 to EFFk, and the number of D flip-flops LFF must be adjusted.

(Effects)

Original effects of liquid crystal display device of the fourteenth embodiment are described below. In the fourteenth embodiment, as mentioned above, by shortening the lighting time of divided backlights 21 to 24, lighting (emission) is terminated within the time of achieving the target transmissivity of all pixels in the corresponding divided regions DA1 to DA4.

As a result, the liquid crystal display device in the fourteenth embodiment has the same effects as in the twelfth embodiment, and can achieve a favorable moving image display performance in all apparatuses mounting transmission type liquid crystal display device for displaying moving images.

Further, in the liquid crystal display device in the fourteenth embodiment, in the same manner as in the thirteenth embodiment, by combining black screen insertion and backlight lighting and extinguishing, the response performance is enhanced without using expensive frame memory, and image display of impulse response type is realized at same power consumption without losing brightness by the liquid crystal module in the write response time same as in the conventional performance.

In divided regions DA1 to DA4, by setting the emission time of divided backlights 21 to 24 in the period of all pixels settling at target transmissivity, more accurate and stable gradation display is realized. Further, since backlights are not lit (emitted) in the period of black image display, efficiency of use of quantity of emission is not lowered.

As a result, the liquid crystal display device in the fourteenth embodiment can achieve a favorable moving image display performance in all apparatuses mounting transmission type liquid crystal display device for displaying moving images.

### Fifteenth Embodiment

(Entire Configuration)

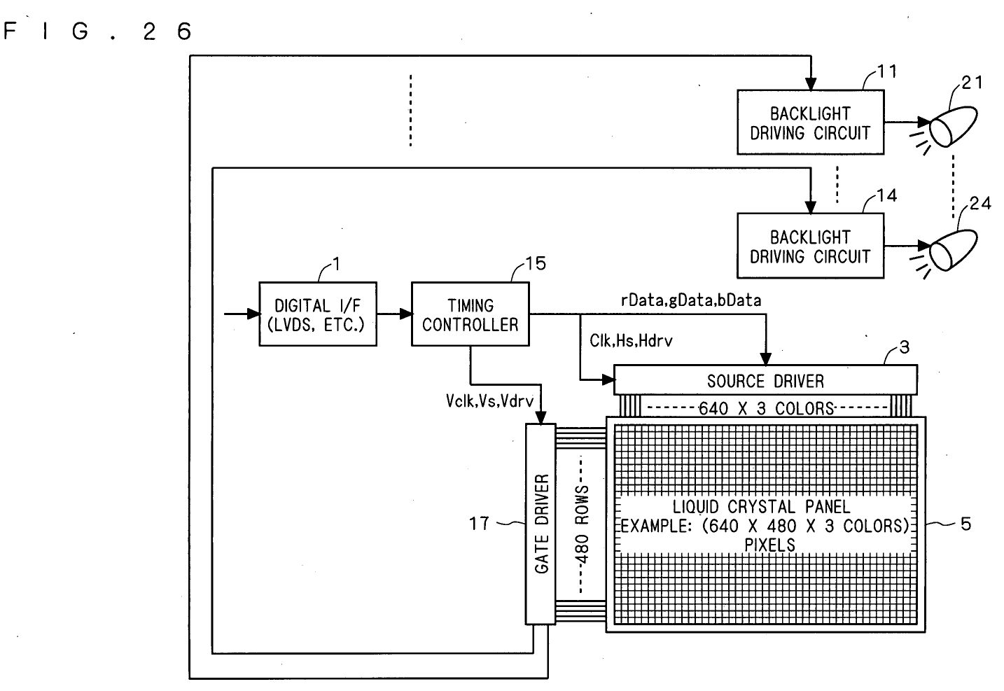

FIG. 26 is a block diagram of backlight of liquid crystal display device in a fifteenth embodiment. This liquid crystal display device shows a structure of liquid crystal display panel having a display screen of pixel composition of 640 columns×3 colors×480 rows.

The liquid crystal display device mainly comprises a liquid crystal panel 5 having color pixels arrayed in matrix, a source driver 3, a gate driver 17, a timing controller 15, a digital I/F 1, backlight driving circuits 11 to 14, and divided backlights 21 to 24.

A digital signal transmitted from the digital IF circuit of television is received in the receiver of digital I/F 1, and is put into the timing controller 15.

The timing controller 15 sends image data (analog image signal rData, analog image signal gData, analog image signal bData) to the source driver 3 at proper timing, and generates transfer clock Clk, horizontal start signal Hs, and horizontal drive signal Hdrv for driving control, and transfers to the source driver 3.

At the same time, the timing controller 15 generates vertical transfer clock Vclk, vertical start signal Vs, and vertical drive signal Vdrv, and transmits to the gate driver 17.

The source driver 3 takes in image data of one row portion in every color pixel from the sent signals, and transmits corresponding image signals to the source wiring in batch from the output terminal.

On the other hand, the gate driver 17 issues an ON signal at a proper timing to the gate wiring so as to synchronize to send image data of one row portion in batch from the source driver 3, and to turn on the MOS transistor of color pixel of corresponding row.

The gate driver 17 has the same structure as the gate driver 4 shown in FIG. 2, and incorporates the backlight on/off control unit for controlling he backlight driving circuits 11 to 14.

The internal structure of the backlight on/off control unit is a same circuit as the backlight on/off control unit in the timing controller 2 in the first embodiment shown in FIG. 9. However, as D flip-flops BFF1 to BFF480 and AND gates BG1 to BG480 in FIG. 9, D flip-flops FF1 to FF480 and AND gates AG1 to AG480 (the circuits of gate driver 17) in FIG. 2 can be used commonly.

The basic operation of source driver 3 and gate driver 4 is same as in the first embodiment shown in FIG. 3.

(Structure of Backlight)

The structure of backlight in the fifteenth embodiment is same as the structure of backlight shown in any one of the first to eleventh embodiments.

(Light Guide Plate)

The light guide plate in the fifteenth embodiment is same as the light guide plate (light guide plate 8 or light guide plate 9) conforming to the structure of backlight shown in any one of the first to eleventh embodiments.

(Control Operation)

Control operation of liquid crystal display device in the fifteenth embodiment is same as the control operation in the first embodiment shown in FIG. 8, or the control operation in any one of the twelfth to fourteenth embodiments shown in FIG. 23 to FIG. 25.

(Backlight On/Off Control Unit)

The backlight on/off control unit in the fifteenth embodiment is realized by installing in the gate driver 17. However, it is necessary to control lighting and extinguishing of divided backlights 21 to 24 at the timing shown in FIG. 25.

(Effects)

In the fifteenth embodiment, the backlight driving circuits 11 to 14 are controlled by assembling the backlight on/off control unit in the gate drive 17.

Therefore, the circuit configuration of the liquid crystal panel 5 can be realized only by adding and modifying the backlight circuit system, and changes of timing controller 15, source driver 3, and gate driver 17 are kept to a minimum. In the gate driver 17, since part of the structure originally used in the gate driver can be commonly used in the backlight on/off control unit, the degree of integration can be enhanced.

### Sixteenth Embodiment

(Entire Configuration)

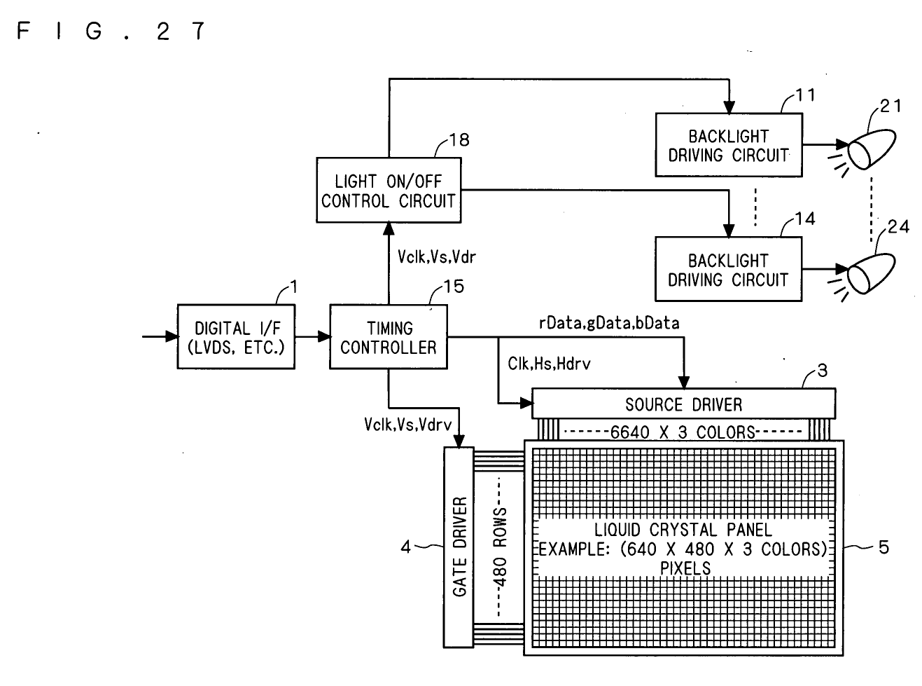

FIG. 27 is a block diagram of backlight of liquid crystal display device in a sixteenth embodiment. This liquid crystal display device shows a structure of liquid crystal display panel having a display screen of pixel composition of 640 columns×3 colors×480 rows.

The liquid crystal display device mainly comprises a liquid crystal panel 5 having color pixels arrayed in matrix, a source driver 3, a gate driver 4, a timing controller 15, a lighting control circuit 18, a digital I/F 1, backlight driving circuits 11 to 14, and divided backlights 21 to 24.

A digital signal transmitted from the digital IF circuit of television is received in the receiver of digital I/F 1, and is put into the timing controller 15.

The timing controller 15 sends image data (analog image signal rData, analog image signal gData, analog image signal bData) to the source driver 3 at proper timing, and generates transfer clock Clk, horizontal start signal Hs, and horizontal drive signal Hdrv for driving control, and transfers to the source driver 3.

At the same time, the timing controller 15 generates vertical transfer clock Vclk, vertical start signal Vs, and vertical drive signal Vdrv, and transmits to the gate driver 4 and lighting control circuit 18.

The source driver 3 takes in image data of one row portion in every color pixel from the sent signals, and transmits corresponding image signals to the source wiring in batch from the output terminal.

On the other hand, the gate driver 4 issues an ON signal at a proper timing to the gate wiring so as to synchronize to send image data of one row portion in batch from the source driver 3, and to turn on the MOS transistor of color pixel of corresponding row.

The lighting control circuit 18 is a circuit equivalent to the backlight on/off control unit in the first embodiment shown in FIG. 9, and controls the backlight driving circuits 11 to 14.

(Structure of Backlight)

The structure of backlight in the sixteenth embodiment is same as the structure of backlight shown in any one of the first to eleventh embodiments.

(Light Guide Plate)

The light guide plate in the sixteenth embodiment is same as the light guide plate (light guide plate 8 or light guide plate 9) conforming to the structure of backlight shown in any one of the first to eleventh embodiments.

(Control Operation)

Control operation of liquid crystal display device in the sixteenth embodiment is same as the control operation in the first embodiment shown in FIG. 8, or the control operation in any one of the second to fourteenth embodiments shown in FIG. 23 to FIG. 25.

(Backlight On/Off Control Unit)

As shown in FIG. 27, the backlight on/off control unit in the sixteenth embodiment is provided independently as lighting control circuit 18.

(Effects)

In the sixteenth embodiment, by the independent lighting control circuit 18, the backlight driving circuits 11 to 14 are controlled.

Therefore, the circuit configuration of the liquid crystal panel 5 can be realized only by adding and modifying the backlight circuit system, and changes of timing controller 15, source driver 3, and gate driver 4 are almost unnecessary, and the effects are obtained only by supplying necessary signals from the timing controller 15 to the lighting control circuit 18.

### Seventeenth Embodiment

(Entire Configuration)

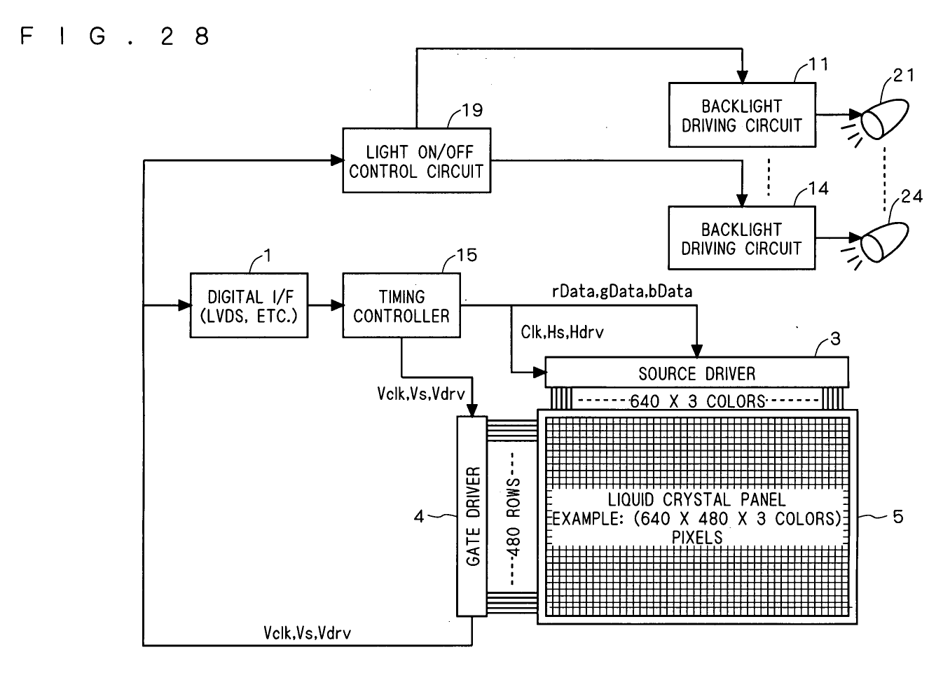

FIG. 28 is a block diagram of backlight of liquid crystal display device in a seventeenth embodiment. This liquid crystal display device shows a structure of liquid crystal display panel having a display screen of pixel composition of 640 columns×3 colors×480 rows.

The liquid crystal display device mainly comprises a liquid crystal panel 5 having color pixels arrayed in matrix, a source driver 3, a gate driver 4, a timing controller 15, a lighting control circuit 19, a digital I/F (circuit) 1, backlight driving circuits 11 to 14, and divided backlights 21 to 24.

A digital signal transmitted from the digital IF circuit of television is received in the receiver of digital I/F 1, and is put into the timing controller 15.

The timing controller 15 sends image data (analog image signal rData, analog image signal gData, analog image signal bData) to the source driver 3 at proper timing, and generates transfer clock Clk, horizontal start signal Hs, and horizontal drive signal Hdrv for driving control, and transfers to the source driver 3.

At the same time, the timing controller 15 generates vertical transfer clock Vclk, vertical start signal Vs, and vertical drive signal Vdrv, and transmits to the gate driver 4.

The source driver 3 takes in image data of one row portion in every color pixel from the sent signals, and transmits corresponding image signals to the source wiring in batch from the output terminal.

On the other hand, the gate driver 4 issues an ON signal at a proper timing to the gate wiring so as to synchronize to send image data of one row portion in batch from the source driver 3, and to turn on the MOS transistor of color pixel of corresponding row.

The gate driver 4 sends out the vertical transfer clock Vclk, vertical start signal Vs, and vertical drive signal Vdrv obtained from the timing controller 15 to the lighting control circuit 19.

The lighting control circuit 19 is a circuit equivalent to the backlight on/off control unit in the first embodiment shown in FIG. 9, and controls the backlight driving circuits 11 to 14.

(Structure of Backlight)

The structure of backlight in the seventeenth embodiment is same as the structure of backlight shown in any one of the first to eleventh embodiments.

(Light Guide Plate)

The light guide plate in the seventeenth embodiment is same as the light guide plate (light guide plate 8 or light guide plate 9) conforming to the structure of backlight shown in any one of the first to eleventh embodiments.

(Control Operation)

Control operation of liquid crystal display device in the seventeenth embodiment is same as the control operation in the first embodiment shown in FIG. 8, or the control operation in any one of the twelfth to fourteenth embodiments shown in FIG. 23 to FIG. 25.

(Backlight On/Off Control Unit)

As shown in FIG. 28, the backlight on/off control unit in the seventeenth embodiment is provided independently as lighting control circuit 19.

(Effects)

In the seventeenth embodiment, by the independent lighting control circuit 19, the backlight driving circuits 11 to 14 are controlled.

Therefore, the circuit configuration of the liquid crystal panel 5 can be realized only by adding and modifying the backlight circuit system, and changes of timing controller 15, source driver 3, and gate driver 4 are almost unnecessary, and the effects are obtained only by supplying necessary signals from the gate driver 4 to the lighting control circuit 19.

While the invention has been shown and described in detail, the foregoing description is in all aspects illustrative and not restrictive. It is therefore understood that numerous modifications and variations can be devised without departing from the scope of the invention.

What is claimed is:

1. A liquid crystal display device comprising:
a liquid crystal panel for displaying an image on a display screen composed of pixels in M columns and N rows, said display screen including plural divided regions divided by a specified number of rows;
a plurality of divided backlight means disposed corresponding to said plural divided regions on said display screen, for illuminating corresponding divided regions respectively, said plurality of divided backlight means each including an emission light source disposed at the lateral side of said display screen in a plan view as seen from said display screen of said liquid crystal panel, and a partial light guide portion for guiding the incident light from said emission light source so as to illuminate the corresponding divided region of said liquid crystal panel; and
backlight on/off control units for performing backlight on/off control operation for controlling lighting and extinguishing of the plurality of divided backlight means, wherein
said backlight on/off control operation includes a control operation for illuminating the corresponding divided backlight means at least in part of the period of reaching a target transmissivity defined by said image data in each one of said plural divided regions, and for lighting and extinguishing said plurality of divided backlight means in one frame period, respectively.

2. The liquid crystal display device of claim 1, wherein
said emission light sources of said plurality of divided backlight means are disposed along a lateral side of said display screen in said plan view.

3. The liquid crystal display device of claim 1, wherein
said emission light sources include first and second emission light sources, and
said first emission light sources of said plurality of divided backlight means are disposed along one lateral side of said display screen in said plan view, and
said second emission light sources of said plurality of divided backlight means are disposed along other lateral side of said display screen in said plan view.

4. The liquid crystal display device of claim 1, wherein
said plurality of divided backlight means are classified into first and second divided backlight groups,
said emission light sources of the divided backlight means in said first divided backlight group are disposed along one lateral side of said display screen in said plan view, and
said emission light sources of the divided backlight means in said second divided backlight group are disposed along other lateral side of said display screen in said plan view.

5. The liquid crystal display device of claim 1, wherein
said emission light sources include ray emission light sources.

6. The liquid crystal display device of claim 1, wherein
said emission light sources include spot emission light sources.

7. The liquid crystal display device of claim 6, wherein
said spot emission light sources include RGB spot emission light source groups having at least a set of red spot emission light source, green spot emission light source, and blue spot emission light source.

8. The liquid crystal display device of claim 1, wherein
said partial light guide sections have a light shielding structure of controlling the whole quantity of light emitted from said emission light sources so that the rate of quantity of leak light leaking to said partial light guide section of the divided backlight means outside of the corresponding divided backlight means may be ⅓ or less.

9. The liquid crystal display device of claim 8, wherein
said partial light guide section has a plurality of low refraction regions and a plurality of high refraction regions extended and formed in row direction of said display screen in said plan view, and
said light shielding structure includes a structure of forming said plurality of low refraction regions and said plurality of high refraction regions, alternately in the column direction of said display screen in said plan view.

10. The liquid crystal display device of claim 8, wherein
said light shielding structure includes a boundary having a mirror surface on both sides, provided in the boundary of said partial light guide sections of said plurality of divided backlight means.

11. A liquid crystal display device comprising:
a liquid crystal panel for displaying an image on a display screen composed of pixels in M columns and N rows, said display screen including plural divided regions divided by a specified number of rows;
a plurality of divided backlight means disposed corresponding to said plural divided regions on said display screen, for illuminating corresponding divided regions respectively from spot emission light sources, as light sources; and
backlight on/off control units for performing backlight on/off control operation for controlling lighting and extinguishing of said plurality of divided backlight means, wherein
said backlight on/off control operation includes a control operation for illuminating the corresponding divided backlight means at least in part of the period of reaching a target transmissivity defined by said image data in each one of said plural divided regions, and for lighting and extinguishing said plurality of divided backlight means in one frame period, respectively.

12. The liquid crystal display device of claim 11, wherein
said spot emission light sources are disposed at the back side of the corresponding divided regions on said display screen.

13. The liquid crystal display device of claim 1, wherein
said backlight on/off control operation includes a control operation of illuminating the corresponding divided backlight means only in the period of reaching said target transmissivity in each one of said plural divided regions.

14. The liquid crystal display device of claim 1, further comprising:
a writing mechanism for writing image data and black image data in one frame period.

15. The liquid crystal display device of claim 1, further comprising:
a timing controller for generating a timing signal including at least a vertical clock; and
image writing drivers for writing image data in said liquid crystal panel in row unit on the basis of said vertical clock, wherein
said backlight on/off control operation includes a control operation for illuminating the corresponding divided backlight means only in the period of reaching said target transmissivity in each one of said plural divided regions, and
said writing driver includes a driver for writing image data and black image data in one frame period.

16. The liquid crystal display device of claim 1, further comprising:
a timing controller for generating a timing signal including at least a vertical clock; and
image writing drivers for writing image data in said liquid crystal panel in row unit on the basis of said vertical clock, wherein
said backlight on/off control unit is provided in said timing controller.

17. The liquid crystal display device of claim 1, further comprising:
a timing controller for generating a timing signal including at least a vertical clock; and
image writing drivers for writing image data in said liquid crystal panel in line unit on the basis of said vertical clock, wherein
said backlight on/off control unit is provided in said writing driver.

18. The liquid crystal display device of claim 1, further comprising:
a timing controller for generating a timing signal including at least a vertical clock; and
image writing drivers for writing image data in said liquid crystal panel in row unit on the basis of said vertical clock, wherein
said backlight on/off control unit receives said vertical clock from said timing controller, and is provided separately from said timing controller.

19. The liquid crystal display device of claim 1, further comprising:
a timing controller for generating a timing signal including at least a vertical clock; and
image writing drivers for writing image data in said liquid crystal panel in row unit on the basis of said vertical clock, wherein
said backlight on/off control unit receives said vertical clock from said writing driver, and is provided separately from said writing driver.

20. The liquid crystal display device of claim 11, wherein
said backlight on/off control operation includes a control operation of illuminating the corresponding divided backlight means only in the period of reaching said target transmissivity in each one of said plural divided regions.

21. The liquid crystal display device of claim 11, further comprising:
a writing mechanism for writing image data and black image data in one frame period.

22. The liquid crystal display device of claim 11, further comprising:
a timing controller for generating a timing signal including at least a vertical clock; and
image writing drivers for writing image data in said liquid crystal panel in row unit on the basis of said vertical clock, wherein
said backlight on/off control operation includes a control operation for illuminating the corresponding divided backlight means only in the period of reaching said target transmissivity in each one of said plural divided regions, and
said writing driver includes a driver for writing image data and black image data in one frame period.

23. The liquid crystal display device of claim 11, further comprising:
a timing controller for generating a timing signal including at least a vertical clock; and
image writing drivers for writing image data in said liquid crystal panel in row unit on the basis of said vertical clock, wherein
said backlight on/off control unit is provided in said timing controller.

24. The liquid crystal display device of claim 11, further comprising:
a timing controller for generating a timing signal including at least a vertical clock; and
image writing drivers for writing image data in said liquid crystal panel in line unit on the basis of said vertical clock, wherein
said backlight on/off control unit is provided in said writing driver.

25. The liquid crystal display device of claim 11, further comprising:
a timing controller for generating a timing signal including at least a vertical clock; and
image writing drivers for writing image data in said liquid crystal panel in row unit on the basis of said vertical clock, wherein
said backlight on/off control unit receives said vertical clock from said timing controller, and is provided separately from said timing controller.

26. The liquid crystal display device of claim 11, further comprising:
a timing controller for generating a timing signal including at least a vertical clock; and
image writing drivers for writing image data in said liquid crystal panel in row unit on the basis of said vertical clock, wherein
said backlight on/off control unit receives said vertical clock from said writing driver, and is provided separately from said writing driver.
